(19) United States
(12) Patent Application Publication
(10) Pub. No.: US 2025/0193631 A1
(43) Pub. Date: Jun. 12, 2025

(54) Spatial Audio Rendering of Reverberation

(71) Applicant: Nokia Technologies Oy, Espoo (FI)

(72) Inventors: Antti Johannes ERONEN, Tampere (FI); Sujeet Shyamsundar MATE, Tampere (FI); Otto Viljami HARJU, Tampere (FI)

(21) Appl. No.: 18/843,370

(22) PCT Filed: Feb. 22, 2023
(86) PCT No.: PCT/EP2023/054353

§ 371 Date: Sep. 3, 2024

(30) Foreign Application Priority Data
Mar. 7, 2022 (GB) 2203120.7

(51) Int. Cl. H04S 7/00; G10K 15/12

(52) U.S. Cl. CPC H04S 7/305; G10K 15/12; H04S 7/303

(57) ABSTRACT

An apparatus for assisting spatial rendering in at least two acoustic environments, the apparatus including circuitry configured to: obtain a listener position; determine a first acoustic environment of the at least two acoustic environments based on the listener position; determine at least one second acoustic environment of the at least two acoustic environments based on the first acoustic environment, wherein the second acoustic environment is coupled to the first acoustic environment by an active portal connection; obtain at least one second acoustic environment input audio signal; and generate at least one listener output audio signal based at least partly on the application of processing of the at least one second acoustic environment input audio signal by at least one second acoustic environment reverberator and then a first acoustic environment reverberator.

### FIELD

The present application relates to apparatus and methods for spatial audio rendering of reverberation, but not exclusively for spatial audio rendering of reverberation in augmented reality and/or virtual reality apparatus.

### BACKGROUND

Reverberation refers to the persistence of sound in a space after the actual sound source has stopped. Different spaces are characterized by different reverberation characteristics. For conveying spatial impression of an environment, reproducing reverberation perceptually accurately is important. Room acoustics are often modelled with individually synthesized early reflection portion and a statistical model for the diffuse late reverberation. FIG. 1 depicts an example of a synthesized room impulse response where the direct sound 101 is followed by discrete early reflections 103 which have a direction of arrival (DOA) and diffuse late reverberation 105 which can be synthesized without any specific direction of arrival. The delay d1(t) 102 in FIG. 1 can be seen to denote the direct sound arrival delay from the source to the listener and the delay d2(t) 104 can denote the delay from the source to the listener for one of the early reflections (in this case the first arriving reflection).

One method of reproducing reverberation is to utilize a set of N loudspeakers (or virtual loudspeakers reproduced binaurally using a set of head-related transfer functions (HRTF)). The loudspeakers are positioned around the listener somewhat evenly. Mutually incoherent reverberant signals are reproduced from these loudspeakers, producing a perception of surrounding diffuse reverberation.

The reverberation produced by the different loudspeakers has to be mutually incoherent. In a simple case the reverberations can be produced using the different channels of the same reverberator, where the output channels are uncorrelated but otherwise share the same acoustic characteristics such as RT60 time and level (specifically, the diffuse-to-direct ratio or reverberant-to-direct ratio). Such uncorrelated outputs sharing the same acoustic characteristics can be obtained, for example, from the output taps of a Feedback-Delay-Network (FDN) reverberator with suitable tuning of the delay line lengths, or from a reverberator based on using decaying uncorrelated noise sequences by using a different uncorrelated noise sequence in each channel. In this case, the different reverberant signals effectively have the same features, and the reverberation is typically perceived to be similar to all directions.

Reverberation spectrum or level can be controlled using the diffuse-to-direct ratio (DDR), which describes the ratio of the energy (or level) of reverberant sound energy to the direct sound energy (or the total emitted energy of a sound source).

### SUMMARY

There is provided according to a first aspect an apparatus for assisting spatial rendering in at least two acoustic environments, the apparatus comprising means configured to: obtain a listener position; determine a first acoustic environment of the at least two acoustic environments based on the listener position; determine at least one second acoustic environment of the at least two acoustic environments based on the first acoustic environment, wherein the second acoustic environment is coupled to the first acoustic environment by an active portal connection; obtain at least one second acoustic environment input audio signal; and generate at least one listener output audio signal based at least partly on the application of processing of the at least one second acoustic environment input audio signal by at least one second acoustic environment reverberator and then a first acoustic environment reverberator.

The means may be configured to: obtain at least one third acoustic environment input audio signal; determine at least one further acoustic environment of the at least two acoustic environment, the at least one further acoustic environment coupled to the determined at least one second acoustic environment; and wherein the means configured to obtain the at least one second acoustic environment input audio signal may be configured to generate the at least one second acoustic environment input audio signal based at least partly on the application of processing of the at least one third acoustic environment input audio signal by at least one third acoustic environment reverberator.

The at least one third acoustic environment may be associated with at least one third acoustic environment reverberator parameter for configuring the at least one third acoustic environment reverberator.

The first acoustic environment may be associated with at least one first acoustic environment reverberator parameter for configuring the first acoustic environment reverberator, and the second acoustic environment may be associated with at least one second acoustic environment reverberator parameter for configuring the at least one second acoustic environment reverberator, wherein the means configured to generate at least one listener output audio signal based at least partly on the application of processing of the at least one second acoustic environment input audio signal by at least one second acoustic environment reverberator and then a first acoustic environment reverberator may be configured to: generate a second acoustic environment output audio signal based on the application of a second acoustic environment reverberator configured by the at least one second acoustic environment reverberator parameter to the at least one second acoustic environment input audio signal; and generate an output audio signal based on the application of a first acoustic environment reverberator configured by the at least one first acoustic environment reverberator parameter to the second acoustic environment output audio signal.

The active portal connection may be one of: an uni-directional connection from the second acoustic environment to the first acoustic environment; and a bi-directional connection from the second acoustic environment to the first acoustic environment and from the first acoustic environment to the second acoustic environment.

The active portal connection may be defined with respect to a distance within the first acoustic environment, such that the means configured to determine the second acoustic environment of the at least two acoustic environments based on the first acoustic environment may be configured to determine the listener position is less than the distance within the first acoustic environment.

The means may be further configured to: determine at least one audio element within the at least two acoustic environments; and configure the distance within the first acoustic environment based at least partly on the determination of at least one audio element within the at least two acoustic environments, such that the distance is increased when there are no audio elements in the at least two acoustic environments.

The means configured to determine the at least one audio element may be configured to: obtain bitstream information defining at least one audio element; and determine the at least one audio element based on the bitstream information.

The means may be further configured to obtain a list of the active portal connections for each acoustic environment, wherein the list identifies for a specified acoustic environment any acoustic environment acoustically coupled to the specified acoustic environment.

The means configured to determine a second acoustic environment of the at least two acoustic environments based on the first acoustic environment, wherein the second acoustic environment is associated with at least one second acoustic environment reverberator parameter may be configured to employ the list of active portal connections to determine the second acoustic environment.

The list of the active portal connections for each acoustic environment may comprise priority information associated with the list of active portal connections for each acoustic environment, wherein the means configured to determine a second acoustic environment of the at least two acoustic environments based on the first acoustic environment may be configured to determine the second acoustic environment based on the priority information.

The at least one second acoustic environment reverberator may comprise at least one filter configured to attenuate at least one frequency.

The at least one first acoustic environment reverberator may comprise at least one filter configured to attenuate at least one frequency.

The means may be further configured to apply one of: a gain control multiplier; and a feedback attenuation filter to an audio signal output by the second acoustic environment output before the application of a first acoustic environment reverberator.

According to a second aspect there is provided an apparatus for assisting spatial rendering in at least two acoustic environments, the apparatus comprising means configured to: select a first acoustic environment of the at least two acoustic environments, wherein the first acoustic environment is associated with at least one first acoustic environment reverberator; determine at least one second acoustic environment of the at least two acoustic environments wherein the at least one second acoustic environment is associated with at least one second acoustic environment reverberator and the second acoustic environment is coupled to the first acoustic environment by an active portal connection; and generate a bitstream comprising information identifying the first acoustic environment and the at least one second acoustic environment coupled by an active portal connection.

The means may be configured to determine at least one further acoustic environment of the at least two acoustic environment, the at least one further acoustic environment coupled to the determined at least one second acoustic environment and may be associated with at least one further acoustic environment reverberator and wherein the bitstream may further comprise information identifying the at least one further acoustic environment is coupled to the at least one second acoustic environment.

The active portal connection may be one of: an uni-directional connection from the second acoustic environment to the first acoustic environment; and a bi-directional connection from the second acoustic environment to the first acoustic environment and from the first acoustic environment to the second acoustic environment.

The active portal connection may be defined with respect to a distance within the first acoustic environment, wherein the bitstream further comprises the distance within the first acoustic environment.

The information may be a list of the active portal connections for each acoustic environment, wherein the list identifies for a specified acoustic environment any acoustic environment acoustically coupled to the specified acoustic environment.

The information may further comprise at least one reverberator parameter for configuring the acoustic environment reverberator.

The information may further comprise priority information associated with the list of active portal connections for each acoustic environment.

The at least one second acoustic environment reverberator may comprise at least one filter configured to attenuate at least one frequency.

The at least one first acoustic environment reverberator may comprise at least one filter configured to attenuate at least one frequency.

The information may further comprise information associated with at least one of the active portal connections for configuring at least one of: a gain control multiplier; and a feedback attenuation filter. According to a third aspect there is provided a method for an apparatus for assisting spatial rendering in at least two acoustic environments, the method comprising: obtaining a listener position; determining a first acoustic environment of the at least two acoustic environments based on the listener position; determining at least one second acoustic environment of the at least two acoustic environments based on the first acoustic environment, wherein the second acoustic environment is coupled to the first acoustic environment by an active portal connection; obtaining at least one second acoustic environment input audio signal; and generating at least one listener output audio signal based at least partly on the application of processing of the at least one second acoustic environment input audio signal by at least one second acoustic environment reverberator and then a first acoustic environment reverberator.

The method may further comprise: obtaining at least one third acoustic environment input audio signal; determining at least one further acoustic environment of the at least two acoustic environment, the at least one further acoustic environment coupled to the determined at least one second acoustic environment; and wherein obtaining the at least one second acoustic environment input audio signal may comprise generating the at least one second acoustic environment input audio signal based at least partly on the application of processing of the at least one third acoustic environment input audio signal by at least one third acoustic environment reverberator.

The at least one third acoustic environment may be associated with at least one third acoustic environment reverberator parameter for configuring the at least one third acoustic environment reverberator.

The first acoustic environment may be associated with at least one first acoustic environment reverberator parameter for configuring the first acoustic environment reverberator, and the second acoustic environment may be associated with at least one second acoustic environment reverberator parameter for configuring the at least one second acoustic environment reverberator, wherein generating at least one listener output audio signal based at least partly on the application of processing of the at least one second acoustic environment input audio signal by at least one second acoustic environment reverberator and then a first acoustic environment reverberator may comprise: generating a second acoustic environment output audio signal based on the application of a second acoustic environment reverberator configured by the at least one second acoustic environment reverberator parameter to the at least one second acoustic environment input audio signal; and generating an output audio signal based on the application of a first acoustic environment reverberator configured by the at least one first acoustic environment reverberator parameter to the second acoustic environment output audio signal.

The active portal connection may be one of: an uni-directional connection from the second acoustic environment to the first acoustic environment; and a bi-directional connection from the second acoustic environment to the first acoustic environment and from the first acoustic environment to the second acoustic environment.

The active portal connection may be defined with respect to a distance within the first acoustic environment, such that determining the second acoustic environment of the at least two acoustic environments based on the first acoustic environment may comprise determining the listener position is less than the distance within the first acoustic environment.

The method may further comprise: determining at least one audio element within the at least two acoustic environments; and configuring the distance within the first acoustic environment based at least partly on the determination of at least one audio element within the at least two acoustic environments, such that the distance is increased when there are no audio elements in the at least two acoustic environments.

Determining the at least one audio element may comprise: obtaining bitstream information defining at least one audio element; and determining the at least one audio element based on the bitstream information.

The method may further comprise obtaining a list of the active portal connections for each acoustic environment, wherein the list identifies for a specified acoustic environment any acoustic environment acoustically coupled to the specified acoustic environment.

Determining a second acoustic environment of the at least two acoustic environments based on the first acoustic environment, wherein the second acoustic environment is associated with at least one second acoustic environment reverberator parameter may comprise employing the list of active portal connections to determine the second acoustic environment.

The list of the active portal connections for each acoustic environment may comprise priority information associated with the list of active portal connections for each acoustic environment, wherein determining a second acoustic environment of the at least two acoustic environments based on the first acoustic environment may comprise determining the second acoustic environment based on the priority information.

The at least one second acoustic environment reverberator may comprise at least one filter configured to attenuate at least one frequency.

The at least one first acoustic environment reverberator may comprise at least one filter configured to attenuate at least one frequency.

The method may further comprise applying one of: a gain control multiplier; and a feedback attenuation filter to an audio signal output by the second acoustic environment output before the application of a first acoustic environment reverberator.

According to a fourth aspect there is provided a method for an apparatus for assisting spatial rendering in at least two acoustic environments, the method comprising: selecting a first acoustic environment of the at least two acoustic environments, wherein the first acoustic environment is associated with at least one first acoustic environment reverberator; determining at least one second acoustic environment of the at least two acoustic environments wherein the at least one second acoustic environment is associated with at least one second acoustic environment reverberator and the second acoustic environment is coupled to the first acoustic environment by an active portal connection; and generating a bitstream comprising information identifying the first acoustic environment and the at least one second acoustic environment coupled by an active portal connection.

Determining at least one further acoustic environment of the at least two acoustic environment, the at least one further acoustic environment coupled to the determined at least one second acoustic environment associated with at least one further acoustic environment reverberator and wherein the bitstream may further comprise information identifying the at least one further acoustic environment and may be coupled to the at least one second acoustic environment.

The active portal connection may be one of: an uni-directional connection from the second acoustic environment to the first acoustic environment; and a bi-directional connection from the second acoustic environment to the first acoustic environment and from the first acoustic environment to the second acoustic environment.

The active portal connection may be defined with respect to a distance within the first acoustic environment, wherein the bitstream further comprises the distance within the first acoustic environment.

The information may be a list of the active portal connections for each acoustic environment, wherein the list identifies for a specified acoustic environment any acoustic environment acoustically coupled to the specified acoustic environment.

The information may further comprise at least one reverberator parameter for configuring the acoustic environment reverberator.

The information may further comprise priority information associated with the list of active portal connections for each acoustic environment.

The at least one second acoustic environment reverberator may comprise at least one filter configured to attenuate at least one frequency.

The at least one first acoustic environment reverberator may comprise at least one filter configured to attenuate at least one frequency.

The information may further comprise information associated with at least one of the active portal connections for configuring at least one of: a gain control multiplier; and a feedback attenuation filter.

According to a fifth aspect there is provided an apparatus the apparatus for assisting spatial rendering in at least two acoustic environments, the apparatus comprising at least one processor and at least one memory including a computer program code, the at least one memory and the computer program code configured to, with the at least one processor, cause the apparatus at least to: obtain a listener position; determine a first acoustic environment of the at least two acoustic environments based on the listener position; determine at least one second acoustic environment of the at least two acoustic environments based on the first acoustic environment, wherein the second acoustic environment is coupled to the first acoustic environment by an active portal connection; obtain at least one second acoustic environment input audio signal; and generate at least one listener output audio signal based at least partly on the application of processing of the at least one second acoustic environment input audio signal by at least one second acoustic environment reverberator and then a first acoustic environment reverberator.

The apparatus may be caused to: obtain at least one third acoustic environment input audio signal; determine at least one further acoustic environment of the at least two acoustic environment, the at least one further acoustic environment coupled to the determined at least one second acoustic environment; and wherein the apparatus caused to obtain the at least one second acoustic environment input audio signal may be caused to generate the at least one second acoustic environment input audio signal based at least partly on the application of processing of the at least one third acoustic environment input audio signal by at least one third acoustic environment reverberator.

The at least one third acoustic environment may be associated with at least one third acoustic environment reverberator parameter for configuring the at least one third acoustic environment reverberator.

The first acoustic environment may be associated with at least one first acoustic environment reverberator parameter for configuring the first acoustic environment reverberator, and the second acoustic environment may be associated with at least one second acoustic environment reverberator parameter for configuring the at least one second acoustic environment reverberator, wherein the apparatus caused to generate at least one listener output audio signal based at least partly on the application of processing of the at least one second acoustic environment input audio signal by at least one second acoustic environment reverberator and then a first acoustic environment reverberator may be caused to: generate a second acoustic environment output audio signal based on the application of a second acoustic environment reverberator configured by the at least one second acoustic environment reverberator parameter to the at least one second acoustic environment input audio signal; and generate an output audio signal based on the application of a first acoustic environment reverberator configured by the at least one first acoustic environment reverberator parameter to the second acoustic environment output audio signal.

The active portal connection may be one of: an uni-directional connection from the second acoustic environment to the first acoustic environment; and a bi-directional connection from the second acoustic environment to the first acoustic environment and from the first acoustic environment to the second acoustic environment.

The active portal connection may be defined with respect to a distance within the first acoustic environment, such that the apparatus caused to determine the second acoustic environment of the at least two acoustic environments based on the first acoustic environment may be caused to determine the listener position is less than the distance within the first acoustic environment.

The apparatus may be further caused to: determine at least one audio element within the at least two acoustic environments; and configure the distance within the first acoustic environment based at least partly on the determination of at least one audio element within the at least two acoustic environments, such that the distance is increased when there are no audio elements in the at least two acoustic environments.

The apparatus caused to determine the at least one audio element may be caused to: obtain bitstream information defining at least one audio element; and determine the at least one audio element based on the bitstream information.

The apparatus may be further caused to obtain a list of the active portal connections for each acoustic environment, wherein the list identifies for a specified acoustic environment any acoustic environment acoustically coupled to the specified acoustic environment.

The apparatus caused to determine a second acoustic environment of the at least two acoustic environments based on the first acoustic environment, wherein the second acoustic environment is associated with at least one second acoustic environment reverberator parameter may be caused to employ the list of active portal connections to determine the second acoustic environment.

The list of the active portal connections for each acoustic environment may comprise priority information associated with the list of active portal connections for each acoustic environment, wherein the apparatus caused to determine a second acoustic environment of the at least two acoustic environments based on the first acoustic environment may be caused to determine the second acoustic environment based on the priority information.

The at least one second acoustic environment reverberator may comprise at least one filter configured to attenuate at least one frequency.

The at least one first acoustic environment reverberator may comprise at least one filter configured to attenuate at least one frequency.

The apparatus may be further caused to apply one of: a gain control multiplier; and a feedback attenuation filter to an audio signal output by the second acoustic environment output before the application of a first acoustic environment reverberator.

According to a sixth aspect there is provided an apparatus for assisting spatial rendering in at least two acoustic environments, the apparatus comprising at least one processor and at least one memory including a computer program code, the at least one memory and the computer program code configured to, with the at least one processor, cause the apparatus at least to: select a first acoustic environment of the at least two acoustic environments, wherein the first acoustic environment is associated with at least one first acoustic environment reverberator; determine at least one second acoustic environment of the at least two acoustic environments wherein the at least one second acoustic environment is associated with at least one second acoustic environment reverberator and the second acoustic environment is coupled to the first acoustic environment by an active portal connection; and generate a bitstream comprising information identifying the first acoustic environment and the at least one second acoustic environment coupled by an active portal connection.

The apparatus may be caused to determine at least one further acoustic environment of the at least two acoustic environment, the at least one further acoustic environment coupled to the determined at least one second acoustic environment and may be associated with at least one further acoustic environment reverberator and wherein the bitstream may further comprise information identifying the at least one further acoustic environment is coupled to the at least one second acoustic environment.

The active portal connection may be one of: an uni-directional connection from the second acoustic environment to the first acoustic environment; and a bi-directional connection from the second acoustic environment to the first acoustic environment and from the first acoustic environment to the second acoustic environment.

The active portal connection may be defined with respect to a distance within the first acoustic environment, wherein the bitstream further comprises the distance within the first acoustic environment.

The information may be a list of the active portal connections for each acoustic environment, wherein the list identifies for a specified acoustic environment any acoustic environment acoustically coupled to the specified acoustic environment.

The information may further comprise at least one reverberator parameter for configuring the acoustic environment reverberator.

The information may further comprise priority information associated with the list of active portal connections for each acoustic environment.

The at least one second acoustic environment reverberator may comprise at least one filter configured to attenuate at least one frequency.

The at least one first acoustic environment reverberator may comprise at least one filter configured to attenuate at least one frequency.

The information may further comprise information associated with at least one of the active portal connections for configuring at least one of: a gain control multiplier; and a feedback attenuation filter.

According to a seventh aspect there is provided an apparatus for assisting spatial rendering in at least two acoustic environments, the apparatus comprising: obtaining circuitry configured to obtain a listener position; determining circuitry configured to determine a first acoustic environment of the at least two acoustic environments based on the listener position; determining circuitry configured to determine at least one second acoustic environment of the at least two acoustic environments based on the first acoustic environment, wherein the second acoustic environment is coupled to the first acoustic environment by an active portal connection; obtaining circuitry configured to obtain at least one second acoustic environment input audio signal; and generating circuitry configured to generate at least one listener output audio signal based at least partly on the application of processing of the at least one second acoustic environment input audio signal by at least one second acoustic environment reverberator and then a first acoustic environment reverberator.

According to an eighth aspect there is provided an apparatus for assisting spatial rendering in at least two acoustic environments, the apparatus comprising: selecting circuitry configured to select a first acoustic environment of the at least two acoustic environments, wherein the first acoustic environment is associated with at least one first acoustic environment reverberator; determining circuitry configured to determine at least one second acoustic environment of the at least two acoustic environments wherein the at least one second acoustic environment is associated with at least one second acoustic environment reverberator and the second acoustic environment is coupled to the first acoustic environment by an active portal connection; and generating circuitry configured to generate a bitstream comprising information identifying the first acoustic environment and the at least one second acoustic environment coupled by an active portal connection.

According to a ninth aspect there is provided a computer program comprising instructions [or a computer readable medium comprising program instructions] for causing an apparatus, for assisting spatial rendering in at least two acoustic environments, to perform at least the following: obtain a listener position; determine a first acoustic environment of the at least two acoustic environments based on the listener position; determine at least one second acoustic environment of the at least two acoustic environments based on the first acoustic environment, wherein the second acoustic environment is coupled to the first acoustic environment by an active portal connection; obtain at least one second acoustic environment input audio signal; and generate at least one listener output audio signal based at least partly on the application of processing of the at least one second acoustic environment input audio signal by at least one second acoustic environment reverberator and then a first acoustic environment reverberator.

According to a tenth aspect there is provided a computer program comprising instructions [or a computer readable medium comprising program instructions] for causing an apparatus, for assisting spatial rendering in at least two acoustic environments, to perform at least the following: select a first acoustic environment of the at least two acoustic environments, wherein the first acoustic environment is associated with at least one first acoustic environment reverberator; determine at least one second acoustic environment of the at least two acoustic environments wherein the at least one second acoustic environment is associated with at least one second acoustic environment reverberator and the second acoustic environment is coupled to the first acoustic environment by an active portal connection; and generate a bitstream comprising information identifying the first acoustic environment and the at least one second acoustic environment coupled by an active portal connection.

According to an eleventh aspect there is provided a non-transitory computer readable medium comprising program instructions for causing an apparatus, for assisting spatial rendering in at least two acoustic environments, to perform at least the following: obtain a listener position; determine a first acoustic environment of the at least two acoustic environments based on the listener position; determine at least one second acoustic environment of the at least two acoustic environments based on the first acoustic environment, wherein the second acoustic environment is coupled to the first acoustic environment by an active portal connection; obtain at least one second acoustic environment input audio signal; and generate at least one listener output audio signal based at least partly on the application of processing of the at least one second acoustic environment input audio signal by at least one second acoustic environment reverberator and then a first acoustic environment reverberator.

According to a twelfth aspect there is provided a non-transitory computer readable medium comprising program instructions for causing an apparatus, for assisting spatial rendering in at least two acoustic environments, to perform at least the following: select a first acoustic environment of the at least two acoustic environments, wherein the first acoustic environment is associated with at least one first acoustic environment reverberator; determine at least one second acoustic environment of the at least two acoustic environments wherein the at least one second acoustic environment is associated with at least one second acoustic environment reverberator and the second acoustic environment is coupled to the first acoustic environment by an active portal connection; and generate a bitstream comprising information identifying the first acoustic environment and the at least one second acoustic environment coupled by an active portal connection

According to a thirteenth aspect there is provided an apparatus for assisting spatial rendering in at least two acoustic environments, the apparatus comprising: means configured to obtain a listener position; means configured to determine a first acoustic environment of the at least two acoustic environments based on the listener position; means configured to determine at least one second acoustic environment of the at least two acoustic environments based on the first acoustic environment, wherein the second acoustic environment is coupled to the first acoustic environment by an active portal connection; means configured to obtain at least one second acoustic environment input audio signal; and means configured to generate at least one listener output audio signal based at least partly on the application of processing of the at least one second acoustic environment input audio signal by at least one second acoustic environment reverberator and then a first acoustic environment reverberator.

According to a fourteenth aspect there is provided an apparatus for assisting spatial rendering in at least two acoustic environments, the apparatus comprising: means configured to select a first acoustic environment of the at least two acoustic environments, wherein the first acoustic environment is associated with at least one first acoustic environment reverberator; means configured to determine at least one second acoustic environment of the at least two acoustic environments wherein the at least one second acoustic environment is associated with at least one second acoustic environment reverberator and the second acoustic environment is coupled to the first acoustic environment by an active portal connection; and means configured to generate a bitstream comprising information identifying the first acoustic environment and the at least one second acoustic environment coupled by an active portal connection.

According to a fifteenth aspect there is provided a computer readable medium comprising program instructions for causing an apparatus, for assisting spatial rendering in at least two acoustic environments, to perform at least the following: obtain a listener position; determine a first acoustic environment of the at least two acoustic environments based on the listener position; determine at least one second acoustic environment of the at least two acoustic environments based on the first acoustic environment, wherein the second acoustic environment is coupled to the first acoustic environment by an active portal connection; obtain at least one second acoustic environment input audio signal; and generate at least one listener output audio signal based at least partly on the application of processing of the at least one second acoustic environment input audio signal by at least one second acoustic environment reverberator and then a first acoustic environment reverberator.

According to a sixteenth aspect there is provided a computer readable medium comprising program instructions for causing an apparatus, for assisting spatial rendering in at least two acoustic environments, to perform at least the following: select a first acoustic environment of the at least two acoustic environments, wherein the first acoustic environment is associated with at least one first acoustic environment reverberator; determine at least one second acoustic environment of the at least two acoustic environments wherein the at least one second acoustic environment is associated with at least one second acoustic environment reverberator and the second acoustic environment is coupled to the first acoustic environment by an active portal connection; and generate a bitstream comprising information identifying the first acoustic environment and the at least one second acoustic environment coupled by an active portal connection

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows a model of room acoustics and the room impulse response;

FIG. 2 shows an example environment within which embodiments can be implemented showing an audio scene with an audio portal or acoustic coupling;

FIG. 3 shows schematically an example apparatus within which some embodiments may be implemented;

FIG. 4 shows a flow diagram of the operation of the example apparatus as shown in FIG. 3;

FIG. 5 shows schematically an example reverberator controller as shown in FIG. 3 according to some embodiments;

FIG. 6 shows a flow diagram of the operation of the example reverberator controller as shown in FIG. 5;

FIG. 7 shows schematically an example active portal connection determiner as shown in FIG. 5 according to some embodiments;

FIG. 8 shows a flow diagram of the operation of the example active portal connection determiner as shown in FIG. 7;

FIGS. 9a to 9c show schematically portal connection examples;

FIG. 10 shows schematically an example reverberator as shown in FIG. 3 according to some embodiments;

FIG. 11 shows a flow diagram of the operation of the example reverberator as shown in FIG. 10;

FIG. 12 shows schematically an example reverberator output signals spatialization controller as shown in FIG. 3 according to some embodiments;

FIG. 13 shows a flow diagram of the operation of the example reverberator output signals spatialization controller as shown in FIG. 12;

FIG. 14 shows schematically an example reverberator output signals spatializer as shown in FIG. 3 according to some embodiments;

FIG. 15 shows a flow diagram of the operation of the example Reverberator output signals spatializer as shown in FIG. 14;

FIG. 16 shows schematically an example FDN reverberator as shown in FIG. 11 according to some embodiments;

FIG. 17 shows schematically an example feedback filter designer for the FDN reverberator as shown in FIG. 11 according to some embodiments;

FIG. 18 shows a flow diagram of the operation of the example feedback filter designer as shown in FIG. 18;

FIG. 19 shows schematically an example apparatus with transmission and/or storage within which some embodiments can be implemented; and

FIG. 20 shows an example device suitable for implementing the apparatus shown in previous figures.

### EMBODIMENTS OF THE APPLICATION

The following describes in further detail suitable apparatus and possible mechanisms for parameterizing and rendering audio scenes with reverberation. Thus in some embodiments there is apparatus for rendering spatial audio in at least two acoustic environments or for controlling a reverberator in spatial audio rendering.

As discussed above reverberation can be rendered using, e.g., a Feedback-Delay-Network (FDN) reverberator with a suitable tuning of delay line lengths. An FDN allows to control the reverberation times (RT60) and the energies of different frequency bands individually. Thus, it can be used to render the reverberation based on the characteristics of the room or modelled space. The reverberation times and the energies of the different frequencies are affected by the frequency-dependent absorption characteristics of the room.

As described above the reverberation spectrum or level can be controlled using a diffuse-to-direct ratio, which describes the ratio of the energy (or level) of reverberant sound energy to the direct sound energy (or the total emitted energy of a sound source). In ISO/IEC JTC1/SC29/WG6 N00054 MPEG-I Immersive Audio Encoder Input Format, the input to the encoder is provided as DDR value which indicates the ratio of the diffuse (reverberant) sound energy to the total emitted energy of a sound source. Another well-known measure is the RDR which refers to reverberant-to-direct ratio and which can be measured from an impulse response. The relation between these two, described in ISO/IEC JTC1/SC29/WG6 N0083 MPEG-I Immersive Audio CfP Supplemental Information, Recommendations and Clarifications, Version 1, is that

$$10 * log 10 ( DDR ) = 10 * log 10 ( RDR ) - 41 dB .$$

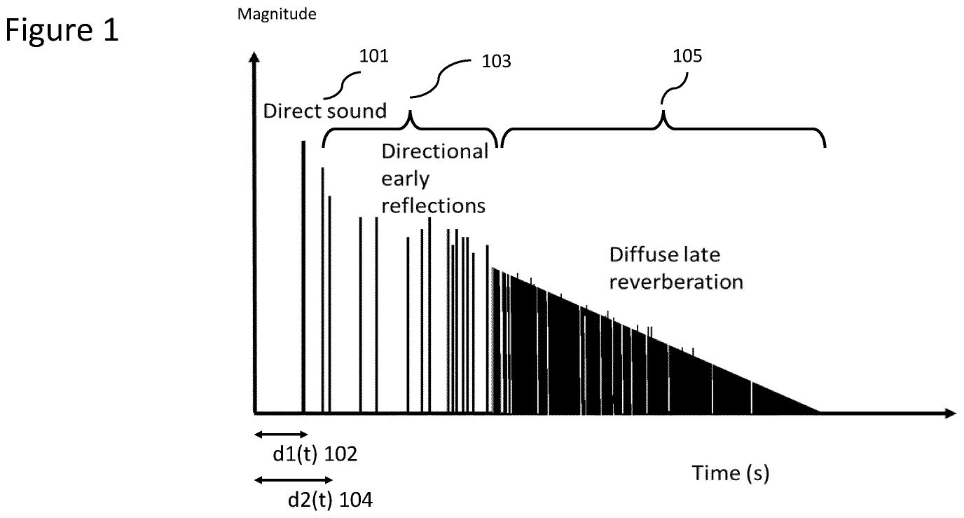

Referring to FIG. 1, the RDR can be calculated by
summing the squares of the sample values of the diffuse late reverberation portion 105
summing the squares of the sample values of the direct sound portion 101
calculating the ratio of these two sums to give the RDR.

The logarithmic RDR can be obtained as 10*log 10 (RDR).

In a virtual environment for virtual reality (VR) or a real physical environment for augmented reality (AR) there can be several acoustic environments, each with their own reverberation parameters which can be different in different acoustic environments. This kind of environment can be rendered with multiple reverberators running in parallel, so that a reverberator instance is running in each acoustic environment. When the listener is moving in the environment, the current environment reverberation is rendered as an enveloping spatial sound surrounding the user, and the reverberation from nearby acoustic spaces is rendered as via so called acoustic portals. An acoustic portal reproduces the reverberation from the nearby acoustic environment as a spatially extended sound source.

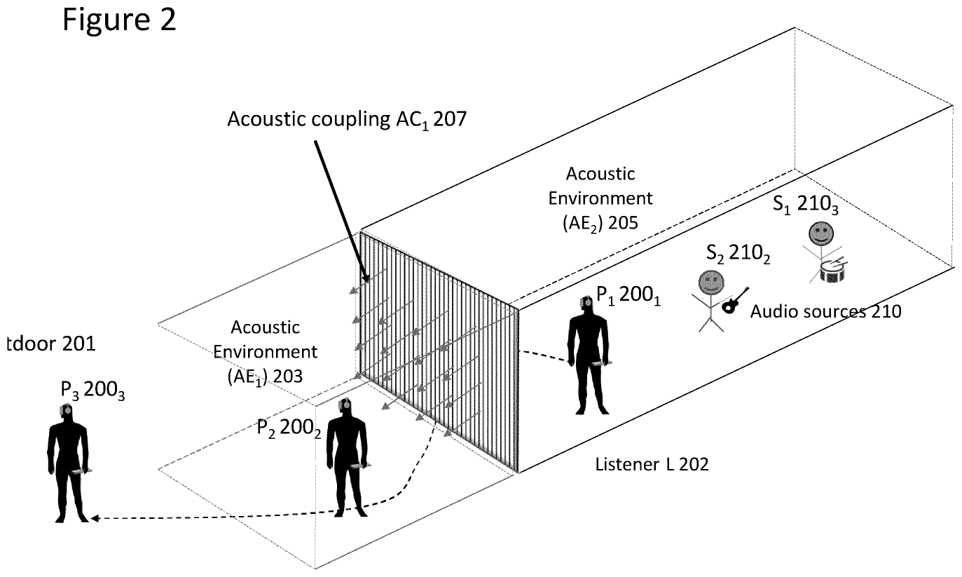

An example of such an environment is shown in FIG. 2. In this example there is shown the audio scene comprising a first acoustic environment AE₁ 203, a second acoustic environment AE₂ 205 and outdoor 201. There is shown an acoustic coupling AC₁ 207 between the first acoustic environment AE₁ 203 and a second acoustic environment AE₂ 205.

In this example the sound or audio sources 210 are located within the second acoustic environment AE₂ 205. In this example the audio sources 210 comprise a first audio source, a drummer, S₁ 2103 and a second audio source, a guitarist, S₂ 2102. The Listener 202 is further shown moving through the audio scene and is shown in the first acoustic environment AE₁ 203 at position P₁ 2001, in the second acoustic environment AE₂ 205 at position P₂ 2002 and outdoor 201 at position P₃ 2003.

Several virtual (for VR) or physical (for AR) acoustic environments can be rendered with several digital reverberators running in parallel, each reproducing the reverberation according to the characteristics of an acoustic environment. The environments can furthermore provide input to each other via so called portals. This means that when an acoustic environment AE₁ 203 is connected to a second acoustic environment AE₂ 205 via a portal or acoustic coupling AC₁ 207, then the reverberated output of AE₁ 203 should also be reverberated with the reverberator associated with AE 2205. This will increase the realism of the audio reproduction as in real connected enclosures the reverberated sound from an enclosure leaks into the connected enclosure and is also reverberated there. If the reverberated sound from the neighbouring environment is not reverberated then the reverberated sound of the neighbouring environment emanating through a portal may thus sound too dry.

Since the portal or acoustic coupling (such as AC₁) is typically two directional (similarly as real acoustic enclosures are connected via an opening), the reverberated output of AE₂ 205 should also be fed into the reverberator associated with AE₁ 203 because, when the listener is in AE₁ 203 it desirable to have also the AE₁ 203 acoustic characteristics affect the reverberated sound of AE₂ 205 and prevent the reverberated signal of AE₂ 205 emanating through the portal from sounding too dry. However, this can create problems with acoustic feedback, where certain audible frequencies recirculate between acoustic environments and get amplified uncontrollably leading to annoying artefacts. This can also be referred as a positive feedback-loop. A typical artefact is an excessively amplified frequency component of the source signal which gets reverberated in the reverberators. Such an artefact can create a howling sound which is very annoying to listen to.

Control of activating/prioritizing reverberators is described in GB2200043.4, which specifically discusses a mechanism of prioritizing reverberators and activating only a subset of them based on the prioritization. GB2200335.4 furthermore describes a method to adjust reverberation level especially in augmented reality (AR) rendering. WO2021186107 describes late reverb modeling from acoustic environment information using FDNs and specifically describes designing a DDR filter to adjust the late reverb level based on input DDR data. GB2020673.6 describes a method and apparatus for fusion of virtual scene description in bitstream and listener space description for 6DoF rendering and specifically for late reverberation modeling for immersive audio scenes where the acoustic environment is a combination of content creator specified virtual scene as well as listener-consumption-space influenced listening space parameters. Thus, this background describes a method for rendering in AR audio scene comprising virtual scene description acoustic parameters and real-world listening-space acoustic parameters. GB2101657.1 describes how late reverb rendering filter parameters are derived for a low latency renderer application. GB2116093.2 discusses reproduction of diffuse reverberation where a method is proposed that enables the reproduction of rotatable diffuse reverberation where the characteristics of the reverberation may be directionally dependent (i.e., having different reverberation characteristics in different directions) using a number of processing paths (at least 3, typically 6-20 paths) (virtual) multichannel signals by determining at least two panning gains based on a target direction and the positions of the (virtual) loudspeakers in a (virtual) loudspeaker set (e.g., using VBAP), obtaining mutually incoherent reverberant signals for each of the determined gains (e.g., using outputs of two reverberators tuned to produce mutually incoherent outputs, or using decorrelators), applying the determined gains for the corresponding obtained reverberant signals in order to obtain reverberant multichannel signals, combining the reverberant multichannel signals from the different processing paths, and reproducing the combined reverberant multichannel signals from the corresponding (virtual) loudspeakers. GB2115533.8 discusses a method for seamless listener transition between acoustic environments.

The concept as discussed in the embodiments in further detail hereafter relates to reproduction of late reverberation in 6DoF audio rendering systems when there are at least two acoustic environments where a second order reverberation (or reverberation of connected acoustic environments) is enabled by rendering reverberation of the first acoustic environment having as an input the reverberated signal from the second acoustic environment without causing acoustic feedback.

In some embodiments this can be achieved by apparatus and methods which are configured to implement the following operations:
obtain listener position(s);
obtain a first acoustic environment (listener AE) based on the listener position;
obtain at least one second acoustic environment connected to the current acoustic environment, based on the first acoustic environment;
obtain reverberators corresponding to the first and second acoustic environment;
receive an output signal of the reverberator corresponding to the second acoustic environment;
provide the output signal (of the digital reverberator corresponding to the second acoustic environment) as an input signal to the reverberator corresponding to the first acoustic environment; and
render late reverberation with the reverberator corresponding to the first acoustic environment using the input signal.

In some embodiments, the apparatus and methods are configured to create a list of active portal connections for each acoustic environment, corresponding to the case when the listener is in the acoustic environment.

Furthermore in some embodiments the method and apparatus is configured to determine the acoustic environments connected to the current listener acoustic environment by processing the list of active portal connections associated with this acoustic environment.

In some embodiments the portal connections in the list are one-way connections.

The apparatus and method furthermore in some embodiments is configured to dynamically determine the depth into which acoustic environments need to be added into the list of active portal connections.

The depth can in some embodiments be based at least partly on the existence of audio elements in the acoustic environments, such that the depth is increased when there are no audio elements in the acoustic environments.

Additionally in some embodiments the determination of whether there are audio elements in an acoustic environment is implemented based on bitstream information.

Thus in some embodiments there is obtained or determined priority information associated with a plurality of active portal connection lists and the apparatus or method selects an active portal connection list to be applied based on the priority information.

A filter is designed in some embodiments to attenuate frequencies which may be amplified excessively because of feedback. The parameters of such a filter may be associated with a virtual scene or with an opening between two acoustic enclosures in the scene.

In some embodiments, there is at least one of gain control multiplier or a feedback attenuation filter, which are applied to the output of a reverberator before it is input to another reverberator to control (reduce) the amount of feedback.

It is understood that ISO/IEC 23090-4 MPEG-I Audio Phase 2 will normatively standardize the bitstream and the renderer processing. There will also be an encoder reference implementation, but it can be modified later on as long as the output bitstream follows the normative spec. This allows improving the codec quality also after the standard has been finalized with novel encoder implementations.

With respect to the embodiments described herein, the portions going to different parts of the ISO/IEC 23090-4 standard could be as follows: the normative bitstream can contain the active portal connection structure corresponding to each of the acoustic environments where the listener can reach. The normative bitstream can also contain information on the depth at which connected acoustic environments need to be rendered, amount of audio elements in the acoustic environments, and gain coefficients or feedback attenuation filters for acoustic environment connections; and the normative renderer can decode the bitstream to obtain scene and reverberator parameters, initialize reverberators for rendering using the reverberator parameters, determine connection information between acoustic environments, and render reverberated signal using the reverberators and the active portal connection information.

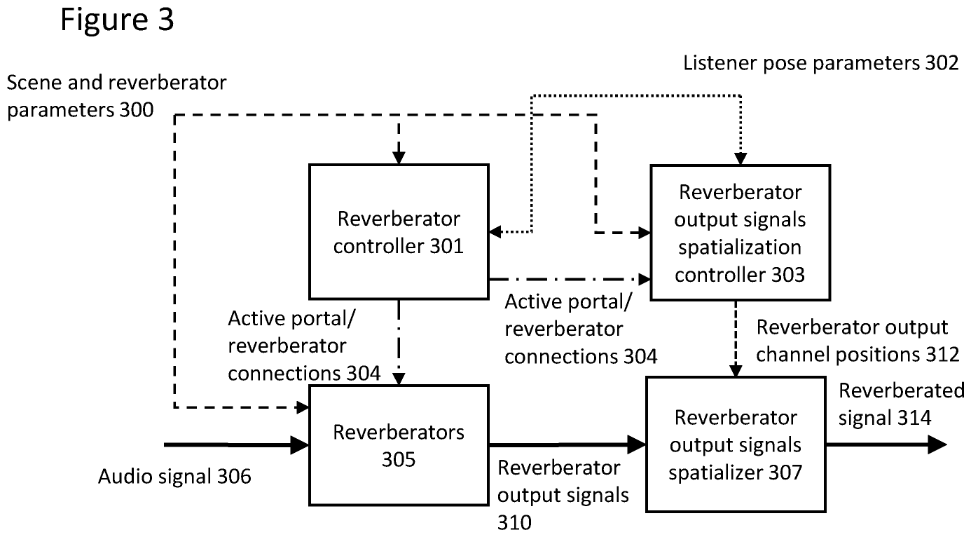

With respect to FIG. 3 is shown an example system of apparatus suitable for implementing some embodiments.

The input to the system of apparatus is scene and reverberator parameters 300, listener pose parameters 302 and audio signal 306. The system of apparatus generates as an output, a reverberated signal 314 (e.g. binauralized with head-related-transfer-function (HRTF) filtering for reproduction to headphones, or panned with Vector-Base Amplitude Panning (VBAP) for reproduction to loudspeakers).

In some embodiments the apparatus comprises a reverberator controller 301. The reverberator controller 301 is configured to obtain or receive the scene and reverberator parameters 300. In some embodiments, the reverberator parameters are in the form of enclosing room geometry and parameters for the digital feedback delay network (FDN) reverberators. The scene and reverberator parameters in some embodiments also contain the positions of the enclosing room geometries (or Acoustic Environments) so that the apparatus or method can determine distances and orientations between the listener and each of the acoustic environments or between acoustic environments. Furthermore in some embodiments the scene and reverberator parameters 300 is configured to contain the positions and geometries of the portals such that sound can pass between acoustic environments.

The reverberator controller 301 is further configured to determine and produce reverberator connections information which indicates which (of several) reverberators should be connected to each other. This active portal/reverberator connections information 304 can change over time and is passed to the reverberators 305 and to the reverberator output signals spatialization controller 303. In order to determine the active portal/reverberator connections information 304, the reverberator controller 301 in some embodiments is configured to utilize any active portal connections information from the scene and reverberator parameters 300 and listener pose parameters 302, from which the controller is configured to determine where the listener currently is in a virtual scene and which acoustic environments are connected to the current acoustic environment in the active portal connections information.

The active portal/reverberator connections 304 signal or information can thus be forwarded to the reverberators 305, which are also configured to receive the audio signal sin (t) (where t is time) 306 and the reverberator parameters from the scene and reverberator parameters 300 as inputs to initialize FDN reverberators to reproduce reverberation according to the reverberator parameters.

Each reverberator within the reverberators is configured to reproduce the reverberation according to the characteristics (reverberation time and level) of an acoustic environment, where the corresponding reverberator parameters are derived from.

In an example embodiment, the reverberator parameters are derived by an encoder based on acoustic environment parameters and written into a bitstream, which the example embodiment of FIG. 3 receives.

In these embodiments the reverberators 305 are therefore configured to reverberate the audio signal 306 based on the reverberator parameters and reverberator connections 304. The details of the reverberation processing are presented further below.

The resulting reverberator output signals S_{rev,r} (j, t) 310 (where j is the output audio channel index and r the reverberator index) are the output of the reverberators. There are several reverberators, each of which produces several output audio signals.

Furthermore the apparatus comprises a reverberator output signals spatialization controller 303 configured to generate the reverberator output channel positions 312. The reverberator output signals spatialization controller 303 is configured to receive the listener pose parameters 302, the active portal/reverberator connections 304 and the scene and reverberator parameters 300 and generate the reverberator output channel positions 312. The reverberator output channel positions 312 in some embodiments indicates cartesian coordinates which are to be used when rendering each of the signals in S_{rev,r} (j, t). In some other embodiments other representations (or other co-ordinate system) such as polar coordinates can be used.

The reverberator output signals 310 are input into a reverberator output signals spatializer 307, which is configured to produce an output signal suitable for reproduction via headphones or via loudspeakers. The reverberator output signals spatializer 307 is further configured to also receive reverberator output channel positions 312 information from the reverberator output signals spatialization controller 303.

The reverberator output channel positions 312 in some embodiments indicates the Cartesian coordinates which are to be used when rendering each of the signals in S_{rev,r} (j, t). In alternative embodiments other co-ordinate or representations such as polar coordinates can be used.

The reverberator output signals spatializer 307 is configured to render each reverberator output signals into a desired output format such as binaural and then sum the signals to produce the output reverberated signal 314. For example for binaural reproduction the reverberator output signals spatializer 307 can be configured to employ HRTF filtering to render the reverberator output signals 310 in their desired positions indicated by the reverberator output channel positions 312.

This reverberation in the reverberated signals 314 in some embodiments is based on the scene and reverberator parameters 310 as was desired and considers listener pose parameters 302.

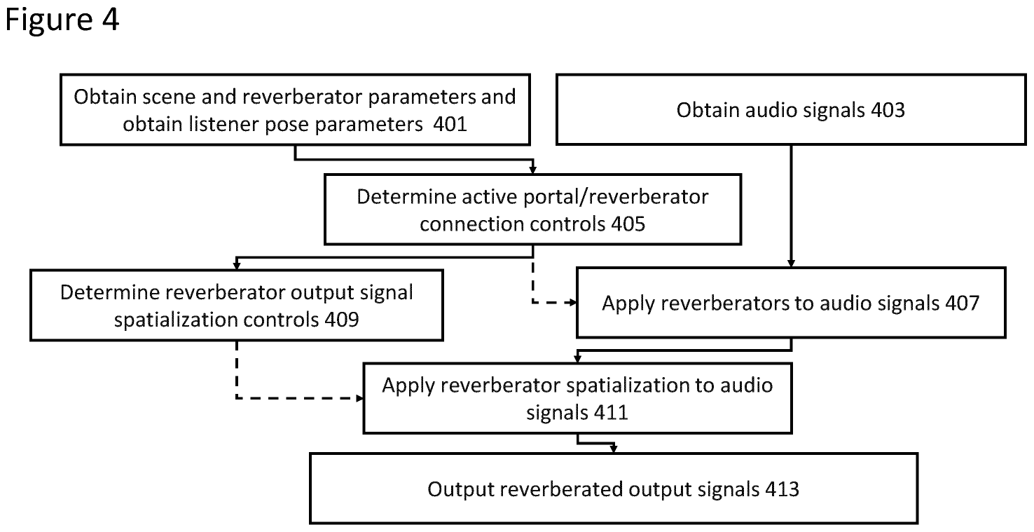

With respect to FIG. 4 is shown a flow diagram showing the operations of example apparatus shown in FIG. 3 according to some embodiments.

Thus, for example, the method may comprise obtaining scene and reverberator parameters and obtaining listener pose parameters as shown in FIG. 4 by step 401.

Furthermore the audio signals are obtained as shown in FIG. 4 by step 403.

Then the active portal/reverberator connection controls are determined based on the obtained scene and reverberator parameters and listener pose parameters as shown in FIG. 4 by step 405.

Then the reverberators controlled by the active portal/reverberator connection controls are applied to the audio signals as shown in FIG. 4 by step 407.

Furthermore the reverberator output signal spatialization controls are determined based on the obtained scene and reverberator parameters, listener pose parameters and active portal/reverberator connection controls as shown in FIG. 4 by step 409.

The reverberator spatialization based on the reverberator output signal spatialization controls can then be applied to the reverberated audio signals from the reverberators to generate output reverberated audio signals as shown in FIG. 4 by step 411.

Then the output reverberated audio signals are output as shown in FIG. 4 by step 413.

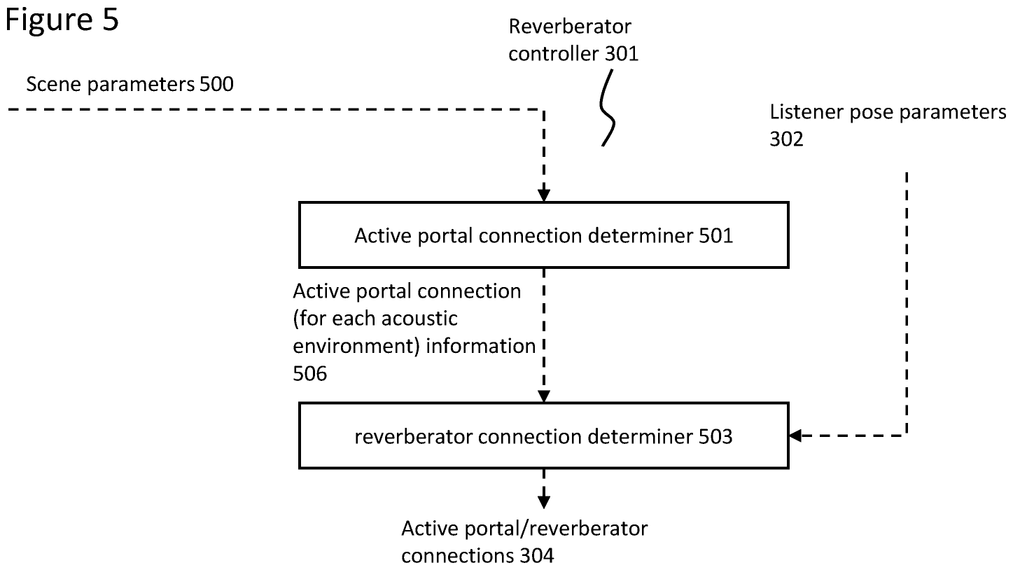

With respect to FIG. 5 there is shown in further detail an example reverberator controller 301. In some embodiments the reverberator controller 301 comprises an active portal connection determiner 501. The active portal connection determiner 501 is configured to receive the scene parameters 500 from the scene and reverberator parameters 300 and determine the active portal connection (for each acoustic environment) information 506 which can be passed to the reverberator connection determiner 503.

Furthermore the reverberator controller 301 comprises a reverberator connection determiner 503. The reverberator connection determiner 503 is configured to receive the active portal connection (for each acoustic environment) information 506 and the listener pose parameters 302 and generate the active portal/reverberator connections 304 information.

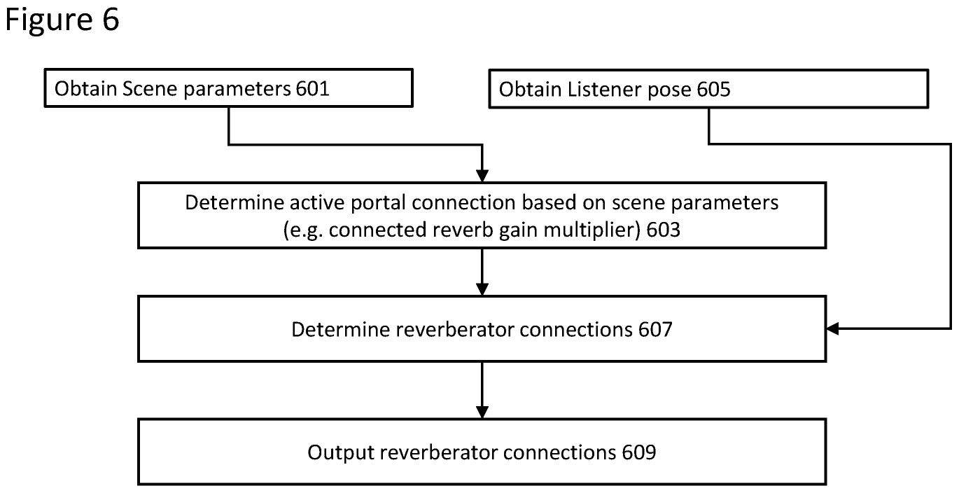

With respect to FIG. 6 is shown a flow diagram showing the operations of the example reverberator controller 301 shown in FIG. 5 according to some embodiments.

Thus in some embodiments there is obtained the scene parameters as shown in FIG. 6 by step 601.

Then based on the scene parameters the method is configured to determine the active portal connection (for each acoustic environment) information as shown in FIG. 6 by step 603.

Furthermore in some embodiments there is obtained the listener pose parameters or information as shown in FIG. 6 by step 605.

Having obtained the listener pose parameters and the active portal connection (for each acoustic environment) information 506 then the method can be configured to determine or generate the active portal/reverberator connections information as shown in FIG. 6 by step 607.

Then the method comprises outputting the generated active portal/reverberator connections information as shown in FIG. 6 by step 609.

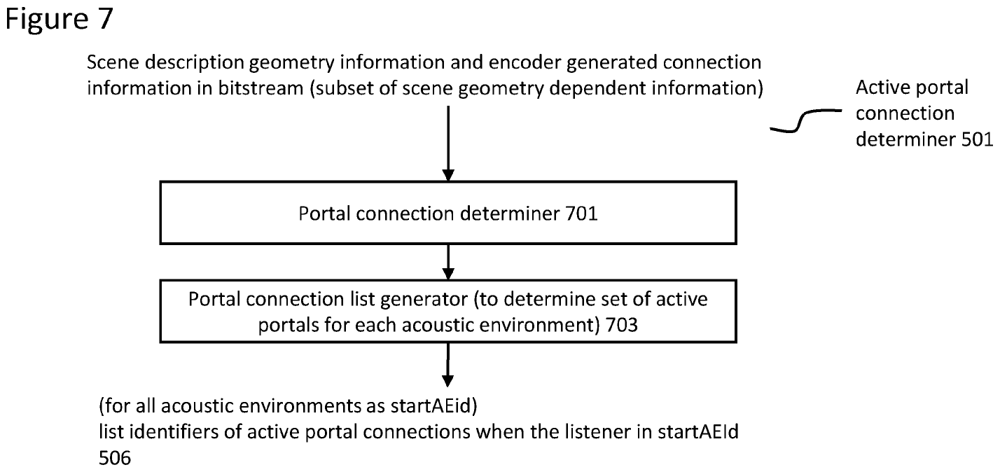

FIG. 7 shows schematically in further detail the active portal connection determiner 501 as shown in FIG. 5. The active portal connection determiner 501 is configured to determine a list of identifiers of active portal connections when the listener is in a defined acoustic environment (which can be identified by the start acoustic environment identifier value-startAEld).

The active portal connection determiner 501 in some embodiments comprises a portal connection determiner 701 which is configured to identify from the scene description geometry information and encoder generated connection information in the bitstream (which can be a sub-set of the scene geometry dependent information) portals and which acoustic environments the portal connects or couples.

Additionally the active portal connection determiner 501 comprises a portal connection list generator 703 which is configured from the output of the portal connection determiner 701 to generate a list of identifiers, configured to identify, the active portal connections when the listener is in the acoustic environment identified by the identifier-startAEld. This list of identifiers of active portal connections when the listener in startAEld 506 can then be output.

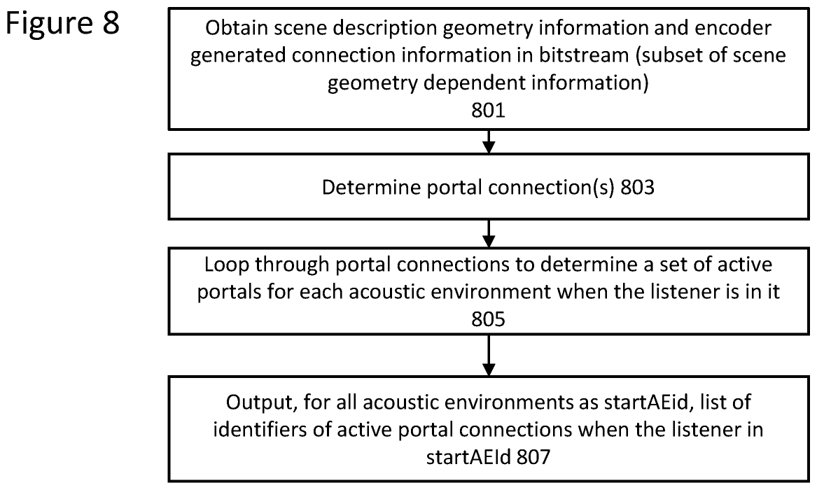

With respect to FIG. 8 is shown a flow diagram of the operation of the example active portal connection determiner 501 shown in FIG. 7.

The method can in some embodiments comprise obtaining scene description geometry information and encoder generated connection information in bitstream (subset of scene geometry dependent information) as shown in FIG. 8 by step 801.

The portal connections are then determined as shown in FIG. 8 by step 803 based on the obtained information.

The operation of looping through portal connections to determine a set of active portals for each acoustic environment (when the listener is in it) is shown in FIG. 8 by step 805.

Then the listed sets of active portals is then output as shown in FIG. 8 by step 807.

In some embodiments the determined active portal connections can thus be a list of portal connections to indicate connections between acoustic environments. In some embodiments, and even where the acoustic connections are two-directional or bi-directional, the list is generated as one-way connections to facilitate feedback-free reverberation rendering.

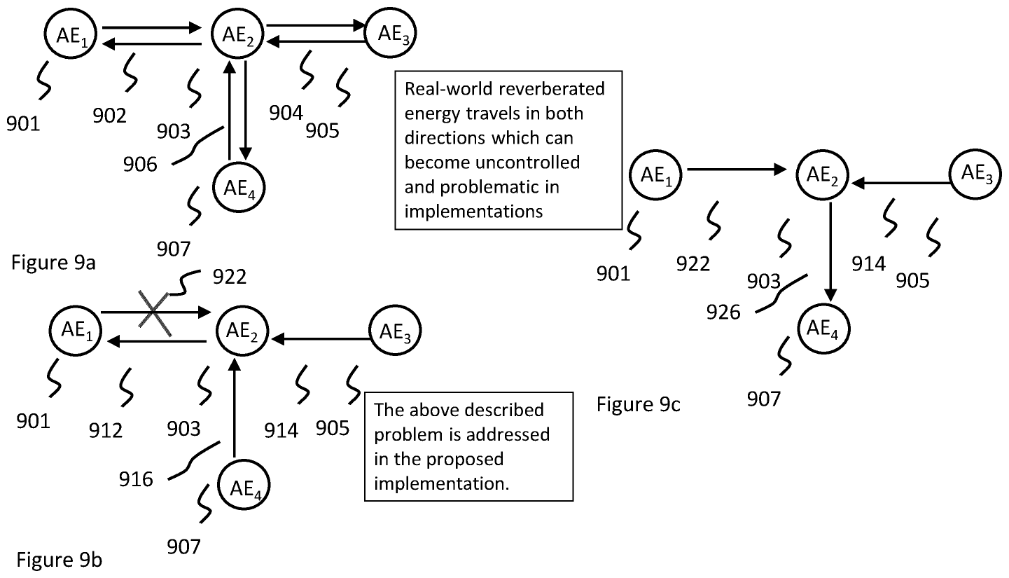

For example FIG. 9a shows schematically a series of acoustic environments labelled 1 to 4, {AE₁ 901, AE₂ 903, AE₃ 905, AE₄ 907} where there are bi-directional connection 902 between AE₁ 901 and AE₂ 903, bi-directional connection 904 between AE₂ 903 and AE₃ 905, and bi-directional connection 906 between AE₂ 903 and AE₄ 907. If reverberation rendering was implemented based on these bi-directional connections there could be problems with acoustic feedback as, for example, reverberation from AE₁ 901 and AE₂ 903 would then return back again to the reverberator of AE₁ 901, and so on, which can lead to undesired amplification of certain frequencies and can, e.g., cause a howling sound artefact.

Instead in the following embodiments a series of one-way active connection data structures are created for possible scenarios of listener being in each of the acoustic environments.

FIG. 9b depicts the active acoustic environment connections when the listener is in AE₁ 901. In this example there is a uni-directional connection or coupling 912 to AE₁ 901 from AE₂ 903, uni-directional connection 914 to AE₂ 903 from AE₃ 905, and uni-directional connection 916 to AE₂ 903 from AE₄ 907. In this example there is no uni-directional connection 922 from AE₁ 901 to AE₂ 903 as this would then lead to reciprocating feedback between AE₁ 901 and AE₂ 903.

FIG. 9c depicts the active acoustic environment connections when the listener is in AE₄ 907. In this example there is a uni-directional connection or coupling 922 from AE₁ 901 to AE₂ 903, uni-directional connection 914 to AE₂ 903 from AE₃ 905, and uni-directional connection 926 from AE₂ 903 to AE₄ 907. Correspondingly, there will be two more sets of active connections created in this case of four acoustic environments, corresponding to the situation when the listener is in the AE₂ 903 and AE₃ 905 (not shown).

List data structures corresponding to each different acoustic environment where the listener can be at can in some embodiments be created as follows. As an input the method receives a data structure indicating pairwise portal connections between acoustic environments. This data structure is obtained from the bitstream and is derived by the encoder by analyzing the scene geometry. The method starts by traversing through all portal connections and obtaining the first acoustic environment in each connection as startAEld.

```
For each acoustic environment startAEId {
  For each portal p connected to startAEId {
    If source of p is not startAEId {
      Add p to active portals for startAEId
      Add source AE of portal p to set of adjacent AEs
    }
  }
  For each acoustic environment AE_a in adjacent AEs {
    For each portal p connected to AE_a {
      If source of p is not startAEId and source of p is not another AE
          in adjacent AEs {
        Add p to active portals for startAEId
        Add source AE of portal p to set of adjacent AEs
      }
    }
  }
}
```

As a result, the above procedure creates a tuple of (startAEld, set {identifiers of active portals when listener in the acoustic environment startAEld}).

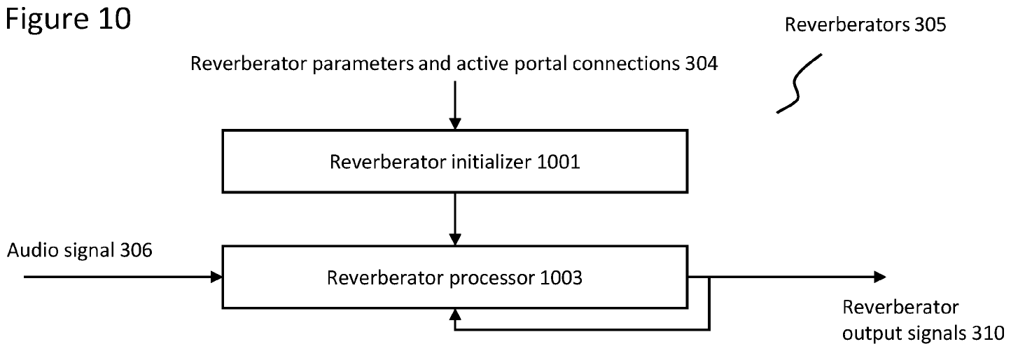

FIG. 10 shows schematically in further detail the reverberators as shown in FIG. 3. The reverberators 305 comprise a reverberator initializer 1001 configured to receive the reverberator parameters and active portal connections information 304/506. The reverberator initializer 1001 is configured to configure or initialize the reverberators whose parameters are provided in the reverberator parameters and controls their processing based on the activation.

In some embodiments the reverberator parameters are parameters for an FDN reverberator as described in further detail below.

In some embodiments the reverberators comprise reverberator processors 1003. The reverberator processors in some embodiments comprise FDN reverberators as shown later each of which is configured by the reverberator initializer 1001. In such embodiments after the parameters for the FDNs have been provided, the audio signal 306 is input into the reverberator processor(s) 1003 to produce a reverberator output signals 310 having desired reverberation characteristics. In some embodiments there are several FDN reverberators running in parallel. For example in some embodiments a FDN can be employed for each Acoustic Environment. In such embodiments each FDN can then be configured with its own parameters and own output signals.

Depending on determined active portal connection information, the reverberator output signals S_{rev,r} (j, t) 310 are provided as at least part of an input to other reverberators. If an acoustic environment corresponding to reverberator r is connected via a portal to an acoustic environment corresponding to a reverberator k, and the corresponding portal connection is currently active based on active portal connection information, then S_{rev,r} (j, t) is provided as an input signal to reverberator k. The output signal S_{rev,r} (j, t) is in an embodiment summed across the output channels j as the reverberators accept a monophonic input.

Providing the output of a reverberator r as an input to reverberator k has the desired effect that the reverberated output S_{rev,r} (j, t) gets reverberated again with the reverberator k.

Consider, for example, a virtual scene comprising a main hall (having a reverberator r) and an entrance room (having reverberator k). In this case it is desired that the reverberated sound of the main hall gets also reverberated in the entrance room.

The routing of reverberator output signals can thus in some embodiments be activated based on the active portal connection information which is different for each listener acoustic environment. Based on listener position, the Reverberator controller 301 determine the listener acoustic environment identifier, which is used as the startAEld to find the active portal connections from the tuple (startAEld, set {identifiers of active portals when the listener in the acoustic environment startAEld}). The determination of the listener acoustic environment identifier can be performed by determining whether the listener position is at least partly located inside a geometric element such as a box or mesh enclosing an acoustic environment, and then obtaining the identifier associated with the acoustic environment. For such determination of whether a position resides within a defined geometric shape known geometric containment checks can, for example, be used. Alternatively or in addition to, determination of whether a listener is within an acoustic environment can be performed at least partly based on a distance between the listener position and the centre of the acoustic environment enclosing geometry or one or more of its boundaries. Active portal connections for this acoustic environment can then be used to find for the identifiers of connected acoustic environments, and their reverberator identifiers. The outputs of reverberators whose identifiers were found based on the active connection information are summed and fed into the reverberator currently being processed by the reverberators 305.

The summed output signal can be multiplied with the coefficient connectedReverbGainMultiplier or ConnectedReverbMultiplier (depending on which is available, see details later). This multiplier can be used to adjust the reverberation to a suitable level. The multiplier value can be adjusted by the encoder and can be adjusted such that no feedback occurs.

The summed output signal can optionally be filtered with a feedback attenuation filter. The coefficients for a feedback attenuation filter can be obtained from the bitstream (see FeedbackAttenuationFilterStruct later). The design procedure for such a filter is described later. Such a filter can be applied if, despite of the one-way connected second order reverberation rendering, still some feedback sound artefacts can occur.

The resulting reverberator output signals S_{rev,r} (j, t) 310 (where j is the output audio channel index and r the reverberator index) are the output of the reverberators 305.

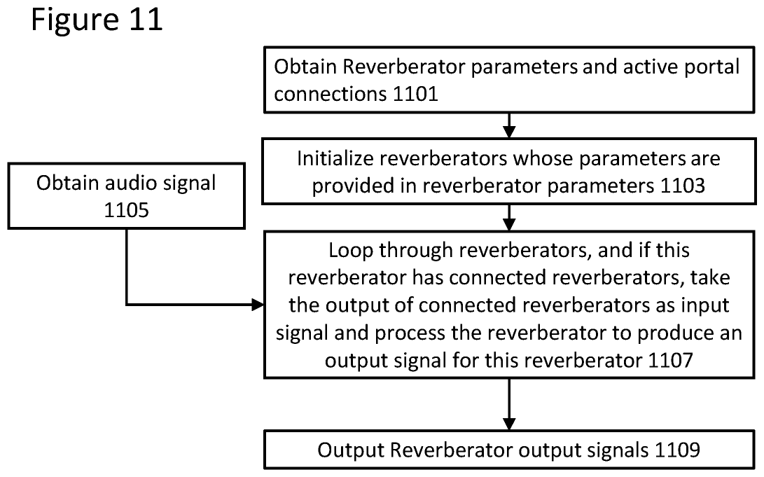

With respect to FIG. 11 is shown a flow diagram of the operation of the reverberators 305 according to some embodiments.

For example the reverberators are configured to obtain the reverberator parameters and active portal connections as shown in FIG. 11 by step 1101.

Then initialize reverberators whose parameters are provided in the reverberator parameters as shown in FIG. 11 by step 1103.

The method may then be configured to obtain audio signals as shown in FIG. 11 by step 1105.

Then loop through reverberators, and if this reverberator has connected reverberators, take the output of connected reverberators as an input signal and process the reverberator to produce an output signal for this reverberator as shown in FIG. 11 by step 1107.

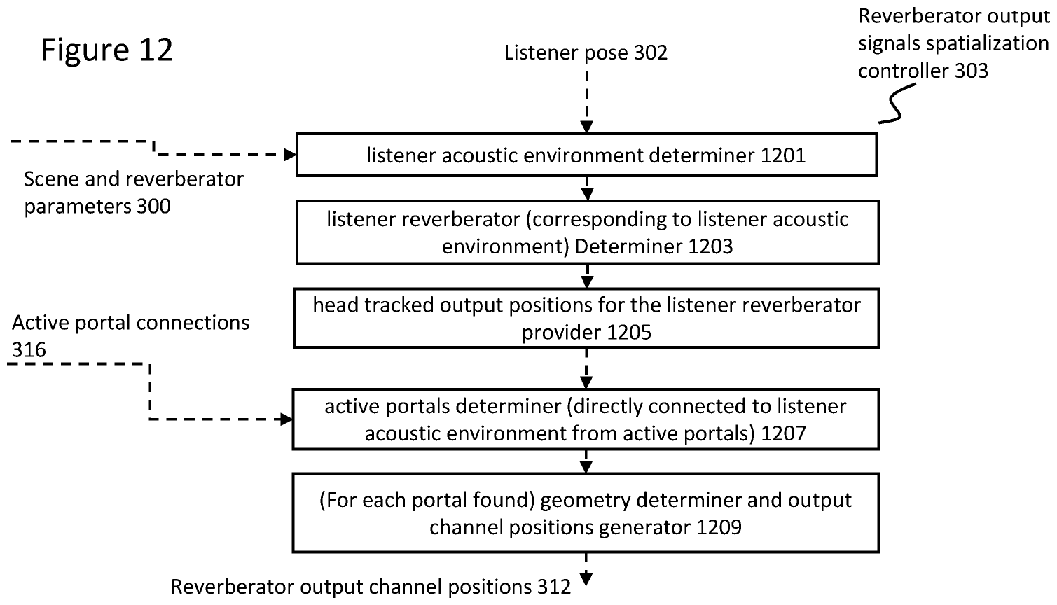

The output of the reverberator output signals (the reverberated audio signals) is shown in FIG. 12 by step 1109.

With respect to FIG. 12 there is shown in further detail the reverberator output signals spatialization controller 303 as shown in FIG. 3.

The reverberator output signals spatialization controller 303 is configured to receive the scene and reverberator parameters 300 and listener pose parameters 302. The reverberator output signals spatialization controller 303 is configured to use the listener pose parameters 302 and scene and reverberator parameters 300 to determine the acoustic environment where the listener currently is and provide that reverberator output channels such positions which surround the listener. This means that the reverberation when inside an acoustic enclosure, caused by that acoustic enclosure, is rendered as a diffuse signal enveloping the listener.

In some embodiments the reverberator output signals spatialization controller 303 comprises a listener acoustic environment determiner 1201 configured to obtain the scene and reverberator parameters 300 and listener pose parameters 302 and determine the listener acoustic environment.

In some embodiments the reverberator output signals spatialization controller 303 comprises a listener reverberator corresponding to listener acoustic environment determiner 1203 which is further configured to determine listener reverberator corresponding to listener acoustic environment information.

In some embodiments the reverberator output signals spatialization controller 303 comprises a head tracked output positions for the listener reverberator provider 1205 configured to provide or determine the head tracked output positions for the listener.

In some embodiments the reverberator output signals spatialization controller 303 comprises an acoustic portals determiner (directly connected to listener acoustic environment from active portals) 1207 which is configured to obtain the active portal connections 316 information and determine portals connected to any acoustic environments connected to listener acoustic environments.

In some embodiments the reverberator output signals spatialization controller 303 comprises a geometry determiner and output channel positions generator 1209 which is configured to obtain the geometry (for each portal) and provide the channel positions for the connected acoustic environment reverberators based on the geometry.

The output of the reverberator output signals spatialization controller 303 is thus the reverberator output channel positions 312.

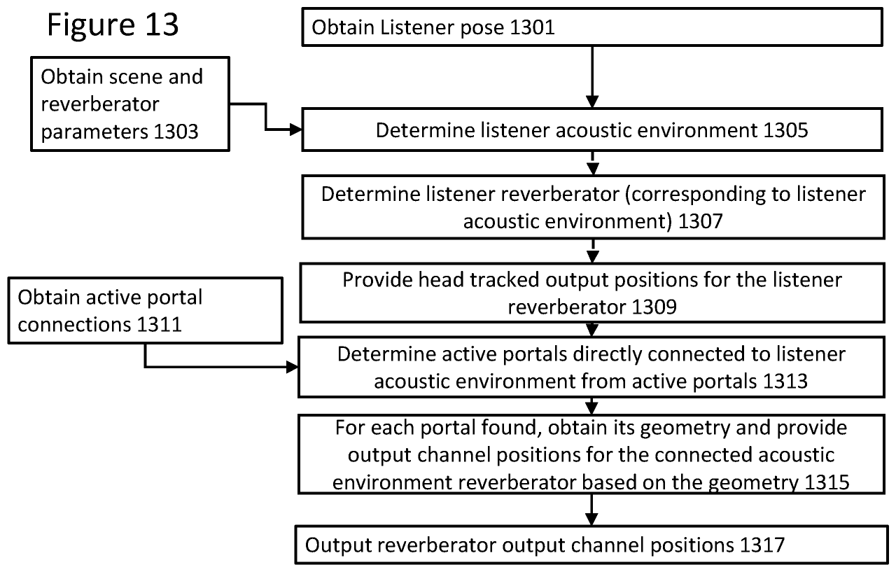

With respect to FIG. 13 is shown the operations of an example reverberator output signals spatialization controller 303 such as shown in FIG. 12 according to some embodiments.

Thus for example is shown obtaining scene and reverberator parameters as shown in FIG. 13 by step 1303 and obtaining listener pose parameters as shown in FIG. 13 by step 1301.

Then the method comprises determining listener acoustic environment as shown in FIG. 13 by step 1305.

Having determined this then determine listener reverberator corresponding to listener acoustic environment as shown in FIG. 13 by step 1307.

Further the method comprises providing head tracked output positions for the listener reverberator as shown in FIG. 13 by step 1309.

The method comprises obtaining the active portal connections as shown in FIG. 13 by step 1311.

The method comprises determining active portals directly connected to the listener acoustic environment from active portals as shown in FIG. 13 by step 1313.

Then the method comprises obtaining geometry for each portal found and providing channel positions for the connected acoustic environment reverberator based on the geometry as shown in FIG. 13 by step 1315.

Then there is outputting reverberator output channel positions as shown in FIG. 13 by step 1317.

In some embodiments, the reverberator corresponding to the acoustic environment where the user currently is, is rendered by the reverberator output signals spatializer 307 as an immersive audio signal surrounding the user. That is, the signals in S_{rev,r} (j, t) corresponding to the listener environment are rendered as point sources surrounding the listener.

Other reverberators may be audible in the current environment via acoustic portals. The reverberator output signals spatialization controller 303 uses portal position information carried in scene parameters to provide in reverberator output channel positions suitable positions for the reverberator outputs which correspond to portals. To obtain a spatially extended perception of the portal sound, the output channels corresponding to reverberators which are to be rendered at a portal are provided positions along the portal geometry which divides two acoustic spaces.

The reverberator output signals spatialization controller uses the listener pose and scene and reverberator parameters to determine the acoustic environment where the listener currently is and provide that reverberator output channel positions surrounding the listener. This means that the reverberation when inside an acoustic enclosure, caused by that acoustic enclosure, is rendered as a diffuse signal enveloping the listener.

Other reverberators may be audible in the current environment with two ways. The first was described in association to FIG. 10, where the output of a connected room reverberator was fed into the current environment reverberator as input signal. This signal, after being reverberated with the current room reverberator, is audible in the immersive output signal of the current room reverberator.

The second way for a neighbour acoustic environment to be audible in the current environment is via directional portal output. The reverberator output signals spatialization controller in some embodiments uses portal position information carried in scene parameters to provide in reverberator output channel positions suitable positions for the reverberator outputs which correspond to portals. To obtain a spatially extended perception of the portal sound, the output channels corresponding to reverberators which are to be rendered at a portal are provided positions along portal geometry which divides two acoustic spaces. The reverberator controller can provide the active portal connection information to the reverberation output signal spatialization controller, and the currently active portals for the listener acoustic environment can be determined based on this.

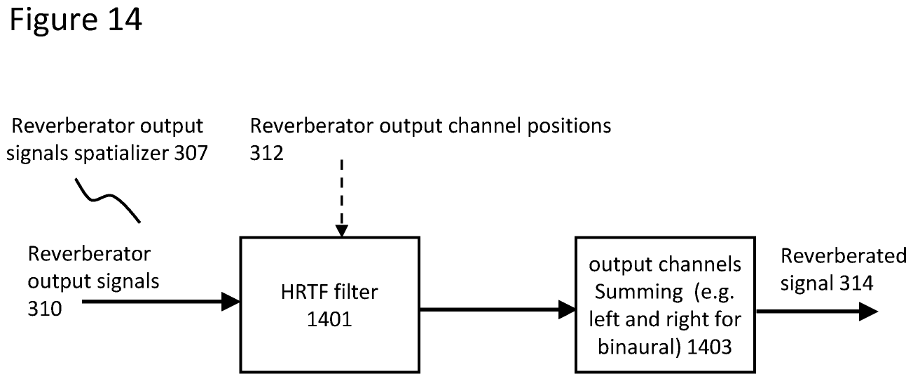

With respect to FIG. 14 there is shown in further detail the reverberator output signals spatializer 307. The reverberator output signals spatializer 307 is configured to receive the positions 312 from the reverberator output signals spatialization controller 303. Additionally is received the reverberator output signals 310 from the reverberators 305.

In some embodiments the reverberator output signals spatializer comprises a head-related transfer function (HRTF) filter 1401 which is configured to render each reverberator output into a desired output format (such as binaural).

Furthermore in some embodiments the reverberator output signals spatializer comprises an output channels combiner 1403 which is configured to combine (or sum) the signals to produce the output reverberated signal 314.

Thus for example for binaural reproduction the reverberator output signals spatializer 307 can use HRTF filtering to render the reverberator output signals in their desired positions indicated by reverberator output channel positions.

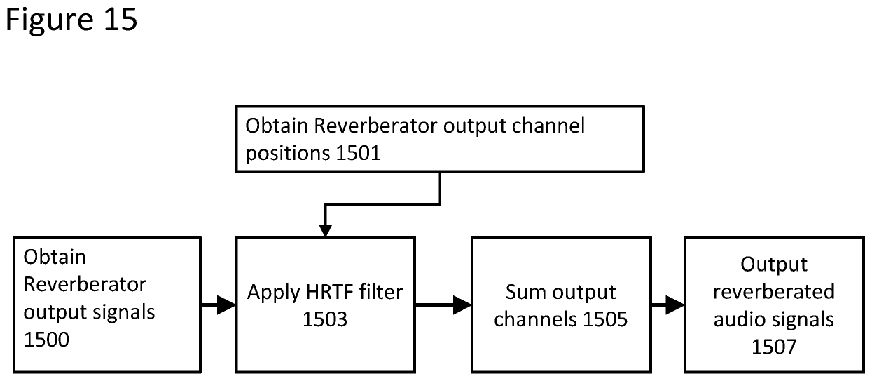

With respect to FIG. 15 is shown a flow diagram showing the operations of the reverberator output signals spatializer according to some embodiments.

Thus the method can comprise obtaining reverberator output signals as shown in FIG. 15 by step 1500 and obtaining reverberator output channel positions as shown in FIG. 15 by step 1501.

Then the method may comprise applying a HRTF filter configured by the reverberator output channel positions to the reverberator output signals as shown in FIG. 15 by step 1503.

The method may then comprise summing or combining the output channels as shown in FIG. 15 by step 1505.

Then the reverberated audio signals can be output as shown in FIG. 15 by step 1507.

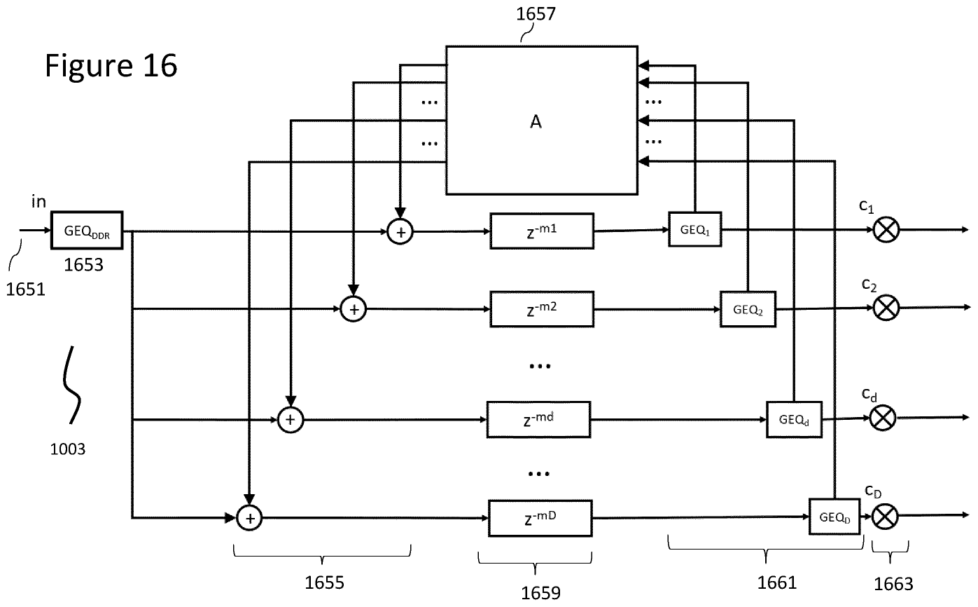

With respect to FIG. 16 is shown an example reverberator (or reverberator processor 1003) according to some embodiments. The reverberator 1003 which is enabled or configured to produce reverberation whose characteristics match the room parameters. There may be several of such reverberators, each parameterized based on the reverberation characteristics of an acoustic environment. An example reverberator implementation comprises a feedback delay network (FDN) reverberator and DDR control filter which enables reproducing reverberation having desired frequency dependent RT60 times and levels. The room parameters are used to adjust the FDN reverberator parameters such that it produces the desired RT60 times and levels. An example of a level parameter can the direct-to-diffuse-ratio (DDR) (or the diffuse-to-total energy ratio as used in ISO/IEC 23090-4). The output from the FDN reverberator are the reverberated audio signals which for binaural headphone reproduction are then reproduced into two output signals and for loudspeaker output means typically more than two output audio signals. Reproducing several outputs such as 15 FDN delay line outputs to binaural output can be done, for example, via HRTF filtering.

FIG. 16 shows an example FDN reverberator in further detail and which can be used to produce D uncorrelated output audio signals. In this example each output signal can be rendered at a certain spatial position around the listener for an enveloping reverb perception.

The example FDN reverberator is configured such that the reverberation parameters are processed to generate coefficients GEQ_{d} (GEQ₁, GEQ₂, . . . . GEQ_{D}) of each attenuation filter 1661, feedback matrix 1657 coefficients A, lengths m_{d} (m₁, m₂, . . . mₚ) for D delay lines 1659 and DDR energy ratio control filter 1653 coefficients GEQ_{ddr}. The example FDN reverberator 1003 thus shows a D-channel output, by providing the output from each FDN delay line as a separate output.

In some embodiments each attenuation filter GEQ_{d} 1661 is implemented as a graphic EQ filter using M biquad IIR band filters. With octave bands M=10, thus, the parameters of each graphic EQ comprise the feedforward and feedback coefficients for biquad IIR filters, the gains for biquad band filters, and the overall gain. In some embodiments any suitable manner may be implemented to determine the FDN reverberator parameters, for example the method described in GB patent application GB2101657.1 can be implemented for deriving FDN reverberator parameters such that the desired RT60 time for the virtual/physical scene can be reproduced.

The reverberator uses a network of delays 1659, feedback elements (shown as attenuation filters 1761, feedback matrix 1657 and combiners 1655 and output gain 1663) to generate a very dense impulse response for the late part. Input samples 1651 are input to the reverberator to produce the reverberation audio signal component which can then be output.

The FDN reverberator comprises multiple recirculating delay lines. The unitary matrix A 1657 is used to control the recirculation in the network. Attenuation filters 1661 which may be implemented in some embodiments as graphic EQ filters implemented as cascades of second-order-section IIR filters can facilitate controlling the energy decay rate at different frequencies. The filters 1661 are designed such that they attenuate the desired amount in decibels at each pulse pass through the delay line and such that the desired RT60 time is obtained. Thus the input to the encoder can provide the desired RT60 times per specified frequencies f denoted as RT60(f). For a frequency f, the desired attenuation per signal sample is calculated as attenuationPerSample (f)=−60/(samplingRate*RT60(f)). The attenuation in decibels for a delay line of length ma is then attenuationDb (f)=m_{d}*attenuationPerSample (f).

The attenuation filters are designed as cascade graphic equalizer filters as described in V. Valimäki and J. Liski, “Accurate cascade graphic equalizer,” IEEE Signal Process. Lett., vol. 24, no. 2, pp. 176-180, February 2017 for each delay line. The design procedure outlined in the paper referenced above takes as an input a set of command gains at octave bands. There are also methods for a similar graphic EQ structure which can support third octave bands, increasing the number of biquad filters to 31 and providing better match for detailed target responses as described in Ramo, J, Liski, J & Valimäki, V 2020, ‘Third-octave and Bark graphic-equalizer design with symmetric band filters’, Applied Sciences (Switzerland), vol. 10, no. 4, 1222. https://doi.org/10.3390/app 10041,222.

Furthermore in some embodiments the design procedure of V. Välimäki and J. Liski, “Accurate cascade graphic equalizer,” IEEE Signal Process. Lett., vol. 24, no. 2, pp. 176-180, February 2017 is also used to design the parameters for the reverb DDR control filter GEQ_{DDR}. The input to the design procedure are the reverberation gains in decibels.

The parameters of the FDN reverberator can be adjusted so that it produces reverberation having characteristics matching the input room parameters. For this reverberator the parameters contain the coefficients of each attenuation filter GEQ_{d}, 1661, feedback matrix coefficients A 1657, lengths ma for D delay lines 1659, and spatial positions for the delay lines d.

The number of delay lines D can be adjusted depending on quality requirements and the desired tradeoff between reverberation quality and computational complexity. In an embodiment, an efficient implementation with D=15 delay lines is used. This makes it possible to define the feedback matrix coefficients A as proposed by Rocchesso: Maximally Diffusive Yet Efficient Feedback Delay Networks for Artificial Reverberation, IEEE Signal Processing Letters, Vol. 4. No. 9, September 1997 in terms of a Galois sequence facilitating efficient implementation.

A length ma for the delay line d can be determined based on virtual room dimensions. For example, a shoebox (or cuboid) shaped room can be defined with dimensions xDim, yDim, zDim. If the room is not cuboid shaped (or shaped as a shoebox) then a shoebox or cuboid can be fitted inside the room and the dimensions of the fitted shoebox can be utilized for the delay line lengths. Alternatively, the dimensions can be obtained as three longest dimensions in the non-shoebox shaped room, or other suitable method.

The delays can in some embodiments can be set proportionally to standing wave resonance frequencies in the virtual room or physical room. The delay line lengths ma can further be configured as being mutually prime in some embodiments.

The parameters of the FDN reverberator are adjusted so that it produces reverberation having characteristics matching the desired RT60 and DDR for the acoustic environment to which this FDN reverberator is to be associated. The adjustment of the parameters is done by the encoder in our current implementation for VR scenes and written into a bitstream, and in the renderer for AR scenes.

Reverberation ratio parameters can refer to the diffuse-to-total energy ratio (DDR) or reverberant-to-direct ratio (RDR) or other equivalent representation. The ratio parameters can be equivalently represented on a linear scale or logarithmic scale.

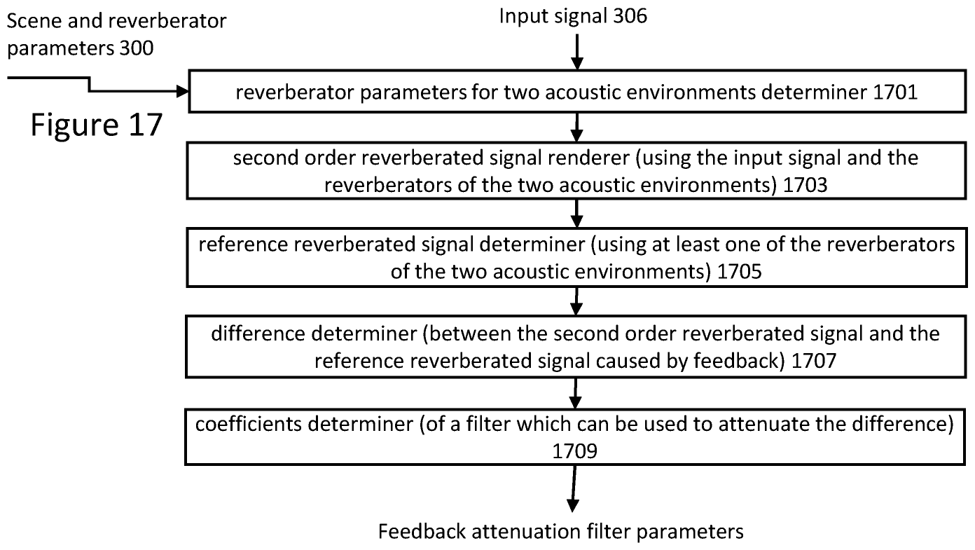

FIG. 17 shows schematically an example feedback attenuation filter determiner configured to determine an attenuation filter for a connection between acoustic environments.

In some embodiments the filter determiner comprises a reverberation parameter for two acoustic environment determiner 1701. The reverberation parameter for two acoustic environment determiner 1701 in some embodiments is configured to obtain the input signal 306 and the scene and reverberation parameters 300 and determine the reverberation parameters for two acoustic environments.

The filter determiner furthermore in some embodiments comprises a second order reverberated signal renderer (using the input signal and the reverberators of the two acoustic environments) 1703 which is configured to render a second order reverberated signal.

The filter determiner further comprises a reference reverberated signal determiner (using at least one of the reverberators of the two acoustic environments) 1705 which is configured to determine a reference reverberated signal.

The filter determiner further comprises a difference determiner 1707 configured to determine a difference between the second order reverberated signal and the reference reverberated signal caused by feedback.

Additionally the filter determiner comprises a coefficients determiner 1709 configured to generate or determine coefficients of a filter which can be used to attenuate the difference. These feedback attenuation filter parameters can then be output.

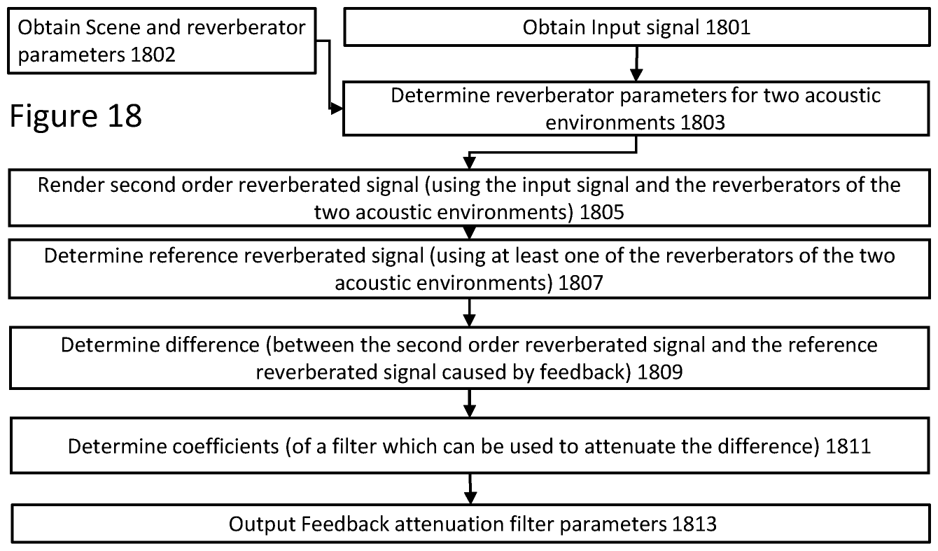

With respect to FIG. 18 is shown an example operation of the filter determiner shown in FIG. 17 according to some embodiments.

The method comprises obtaining an input signal as shown in FIG. 18 by step 1801.

Then obtaining scene and reverberator parameters as shown in FIG. 18 by step 1802.

Having obtained the parameters and input signal, reverberator parameters for two acoustic environments are determined as shown in FIG. 18 by step 1803.

The method can then comprises rendering second order reverberated signal (using the input signal and the reverberators of the two acoustic environments) as shown in FIG. 18 by step 1805.

Following this the method comprises determining reference reverberated signal (using at least one of the reverberators of the two acoustic environments) as shown in FIG. 18 by step 1807.

The method furthermore can comprise determining a difference (between the second order reverberated signal and the reference reverberated signal caused by feedback) as shown in FIG. 18 by step 1809.

Then the method may comprise determining coefficients (of a filter which can be used to attenuate the difference) as shown in FIG. 18 by step 1811.

The feedback attenuation filter parameters can then be output as shown in FIG. 18 by step 1813.

The method can be performed in an encoder device and the coefficients for the feedback attenuation filter can be signalled in the bitstream (see FeedbackAttenuationFilterStruct). The method for feedback attenuation filter design starts as shown above by determining reverberator parameters for reverberators of two connected acoustic environments. This can be the same step as is used for the reverberator parameter obtaining for these acoustic environments, as described above. Then the method renders a reverberated signal using the method described above, including second order reverberation from the two acoustic environments. The input signal can be a suitable wide band signal such as an impulse or a white noise. Then the method determines a reference reverberated signal using at least one of the two reverberators of the two acoustic environments. This reference signal does not have second order reverberation (or its possible feedback artefacts). Then the method proceeds to determine a difference signal between the second order reverberated signal and the reference signal without second order reverberation. The difference signal can be, for example, the logarithmic spectral difference on octave or third octave bands. The method then proceeds to design a filter to attenuate the difference signal. For example, if the difference signal contains high spectral peaks due to feedback from second order reverberation then the designed filter can be a notch filter with notches at the frequencies corresponding to amplified peaks in the difference signal. The same design procedure and graphic EQ filter structure can be used as was earlier used for attenuation filter or DDR control filter design for the digital reverberators. Alternatively, the feedback attenuation filter can be a dedicated notch filter.

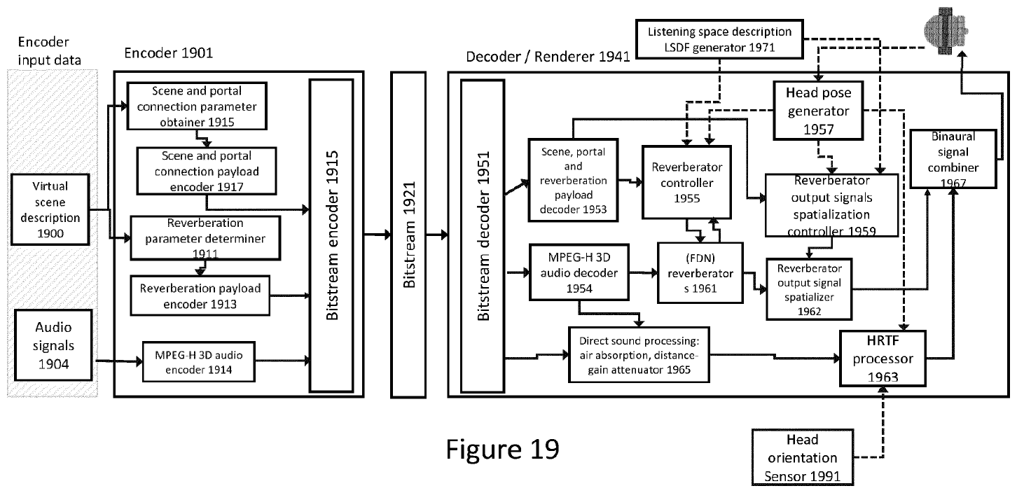

With respect to FIG. 19 is shown a system where the embodiments are implemented in an encoder device 1901 which performs part of the functionality; writes data into a bitstream 1921 and transmits that for a renderer device 1941, which decodes the bitstream, performs reverberator processing according to the embodiments and outputs audio for headphone listening.

The encoder side 1901 of FIG. 19 can be performed on content creator computers and/or network server computers. The output of the encoder is the bitstream 1921 which is made available for downloading or streaming. The decoder/renderer 1941 functionality runs on end-user-device, which can be a mobile device, personal computer, sound bar, tablet computer, car media system, home HiFi or theatre system, head mounted display for AR or VR, smart watch, or any suitable system for audio consumption.

The encoder 1901 is configured to receive the virtual scene description 1900 and the audio signals 1904. The virtual scene description 1900 can be provided in the MPEG-I Encoder Input Format (EIF) or in other suitable format. Generally, the virtual scene description contains an acoustically relevant description of the contents of the virtual scene, and contains, for example, the scene geometry as a mesh, acoustic materials, acoustic environments with reverberation parameters, positions of sound sources, and other audio element related parameters such as whether reverberation is to be rendered for an audio element or not. The encoder 1901 in some embodiments comprises a reverberation parameter determiner 1911 configured to receive the virtual scene description 1900 and configured to obtain the reverberation parameters. The reverberation parameters can in an embodiment be obtained from the RT60, DDR, predelay, and region/enclosure parameters of acoustic environments.

The encoder 1901 furthermore in some embodiments comprises a reverberation payload encoder 1913 configured to obtain the determined reverberation parameters and the reverberation ratio handling parameters and generate reverberation parameters.

The encoder 1901 further comprises a MPEG-H 3D audio encoder 1914 configured to obtain the audio signals 1904 and MPEG-H encode them and pass them to a bitstream encoder 1915.

The encoder 1901 furthermore in some embodiments comprises a scene and portal connection parameter obtainer 1915 configured to obtain from the virtual scene description the scene and portal connection parameters (in a manner such as described above). These scene and portal connection parameters can be passed to a scene and portal connection payload encoder 1917 configured to generate an encoded scene and portal connection parameter to be passed to the bitstream encoder 1915.

The encoder 1901 furthermore in some embodiments comprises a bitstream encoder 1915 which is configured to receive the output of the reverberation payload encoder 1913, the scene and portal connection payload encoder 1917, and the encoded audio signals from the MPEG-H encoder 1914 and generate the bitstream 1921 which can be passed to the bitstream decoder 1941. The bitstream 1921 in some embodiments can be streamed to end-user devices or made available for download or stored.

The decoder 1941 in some embodiments comprises a bitstream decoder 1951 configured to decode the bitstream.

The decoder 1941 further can comprise a reverberation payload decoder 1953 configured to obtain the encoded reverberation parameters and decode these in an opposite or inverse operation to the reverberation payload encoder 1913.

The listening space description LSDF generator 1971 is configured to generate and pass the LSDF information to the reverberator controller 1955 and the reverberator output signals spatialization controller 1959.

Furthermore the head pose generator 1957 receives information from a head mounted device or similar and generates head pose information or parameters which can be passed to the reverberator controller 1955, the reverberator output signals spatialization controller 1959 and HRTF processor 1963.

The decoder 1941, in some embodiments, comprises a reverberator controller 1955 which also receives the output of the scene, portal and reverberation payload decoder 1953 and generates the reverberation parameters for configuring the reverberators and passes this to the reverberators 1961.

In some embodiments the decoder 1941 comprises a reverberator output signals spatialization controller 1959 configured to configured the reverberator output signals spatializer 1962.

The decoder 1941 comprise MPEG-H 3D audio decoder 1954 which is configured to decode the audio signals and pass them to the (FDN) reverberators 1961 and direct sound processing 1955.

The decoder 1941 furthermore comprises (FDN) reverberators 1961 configured by the reverberator controller 1955 and configured to implement a suitable reverberation of the audio signals. In some embodiments prioritizing the reverberators and activating a subset of them can be configured by the reverberation controller 1955.

The output of the (FDN) reverberators 1961 is configured to output to a reverberator output signal spatializer 1962.

In some embodiments the decoder 1941 comprises a reverberator output signal spatializer 1962 configured to apply the spatialization and output to the binaural combiner 1967.

Additionally the decoder/renderer 1941 comprises a direct sound processor 1965 which is configured to receive the decoded audio signals and configured to implement any direct sound processing such as air absorption and distance-gain attenuation and which can be passed to a HRTF processor 1963 which with the head orientation determination (from a suitable sensor 1991) can generate the direct sound component which with the reverberant component from the HRTF processor 1963 is passed to a binaural signal combiner 1967. The binaural signal combiner 1967 is configured to combine the direct and reverberant parts to generate a suitable output (for example for headphone reproduction).

Furthermore in some embodiments the decoder comprises a head orientation determiner 1991 which passes the head orientation information to the HRTF processor 1963.

Although not shown, there can be various other audio processing methods applied such as early reflection rendering combined with the proposed methods.

As indicated earlier ISO/IEC 23090-4 MPEG-I Audio Phase 2 will normatively standardize the bitstream and the renderer processing. There will also be an encoder reference implementation, but it can be modified later on as long as the output bitstream follows the normative specification. This allows improving the codec quality also after the standard has been finalized with novel encoder implementations.

The portions going to different parts of the MPEG-I standard can be:
Encoder reference implementation will contain
   Deriving the reverberator parameters for each of the acoustic environments based on their RT60 and DDR
   Obtaining scene parameters from the encoder input and writing them into the bitstream. This contains at least the positions and geometries of each acoustic enclosure and the positions and geometries of the acoustic portals which connect the acoustic enclosures.
   Obtaining information on active portals for each acoustic environment, when the listener is in it.
   Obtaining information on the presence of audio elements in acoustic environments.
   Writing a bitstream description containing the (optional) reverberator parameters and scene parameters, active portals and presence of audio elements. If there is at least one virtual enclosure with reverberation parameter in the Virtual scene description, then there will be parameters for the corresponding reverberator written into the Reverb payload.
The normative bitstream can contain (optional) reverberator parameters with the second-order reverberation related extensions using the syntax described below. The bitstream can be streamed to end-user devices or made available for download or stored.
The normative renderer can decode the bitstream to obtain the scene and reverberator parameters and perform the reverberation rendering as described in this invention.
   For VR rendering, reverberator and scene parameters are derived in the encoder and sent in the bitstream.
   For AR rendering, reverberator parameters and scene are derived in the renderer based on a listening space description format (LSDF) file or corresponding representation.
The complete normative renderer will also obtain other parameters from the bitstream related to room acoustics and sound source properties, and use them to render the direct sound, early reflection, diffraction, sound source spatial extent or width, and other acoustic effects in addition to diffuse late reverberation. The invention presented here focuses on the rendering of the diffuse late reverberation part and in particular how to enable second order reverberation.

Furthermore there is herein shown example bit stream syntax and semantics descriptions:

In a first example there is shown a bit stream syntax for a connected reverb bitstream information carrying information regarding the depth of connected reverb creation, the connected reverb gain multiplier, presence or absence of active audio sources.

Syntax:

```
  reverbPayloadStruct( ){
  unsigned int(2) numberOfSpatialPositions;
  unsigned int(1) hasConnectedReverbDepthLimit;
  unsigned int(1) hasConnectedReverbGainMultiplier;
  unsigned int(8) numberOfAcousticEnvironments;
  for(int i=0;i<numberOfSpatialPositions;i++){
    signed int(32) azimuth;
    signed int(32) elevation;
  }
  if(hasConnectedReverbDepthLimit){
    unsigned int(3) connectedReverbDepthLimit;
    reserved bits(5) = 0;
  }
  if(hasConnectedReverbGainMultiplier)
    unsigned int(8) connectedReverbGainMultiplier;
  reserved bits(4) = 0;
  for(int i=0;i<numberOfAcousticEnvironments;i++){
    unsigned int(16) environmentsId;
    filterParamsStruct( );
    unsigned int(1) hasActiveAudioSource;
    if(hasActiveAudioSource){
      unsigned int(1)
animated_audio_element_present;
      unsigned int(1) interactive_element_present;
      unsigned int(1)
dynamic_update_element_present;
      reserved bits(5) = 0;
    }
    unsigned int(1)
hasAESpecificConnectedReverbGainMultiplier;
    if(hasAESpecificConnectedReverbGainMultiplier){
      unsigned int(8)
AEConnectedReverbGainMultiplier;
    }
    reserved bits(6) = 0;
    for(int j=0;j<numberOfSpatialPositions;j++){
      unsigned int(32) delayLineLength;
      filterParamsStruct( );
    }
  }
}
  aligned(8) filterParamsStruct( ){
    SOSLength;
    If(SOSLength>0){
      for (i=0;i<SOSLength;i++){
        signed int(32) b1;
      }
      for (i=0;i<SOSLength;i++){
        signed int(32) b2;
      }
      for (i=0;i<SOSLength;i++){
        signed int(32) a1;
      }
      for (i=0;i<SOSLength;i++){
        signed int(32) a2;
      }
    signed int(32) globalGain;
    signed int(32) levelDb;
    }
  }
```

Where numberOfSpatialPositions defines the number of delay line positions for the late reverb payload. This value is defined using an index which corresponds to a specific number of delay lines. The value of the bit string ‘0b00’ signals the renderer to a value of 15 spatial orientations for delay lines. The other three values ‘0b01’, ‘0b10’ and ‘0b11’ are reserved.
azimuth defines azimuth of the delay line with respect to the listener. The range is between-180 to 180 degrees.
elevation defines the elevation of the delay line with respect to the listener. The range is between-90 to 90 degrees.
hasConnectedReverbDepthLimit equal to 1 indicates the presence of information regarding the number of acoustic environments that can be used for connected reverb rendering. A value equal to 0 indicates that the renderer can use its own defaults and there is no information regarding this in the bitstream.
connectedReverbDepthLimit defines the upper limit in terms of number of acoustic environments that can be connected in a daisy chain fashion to feed the reverb in the listener's current acoustic environment. This being an upper bound, consequently, the different renderers dynamically choose their own criteria (depending on the computational load) to select a smaller number.
hasConnectedReverbGainMultiplier equal to 1 indicates presence of information regarding the reverb output gain multiplier before feeding it as input to the next reverb for connected reverb rendering. A value equal to 0 indicates that this information is not present at a global level for all acoustic environments.
connectedReverbGainMultiplier indicates the gain multiplier value which is applied to the summed output of a reverb before feeding it as input to the next reverb for connected reverb rendering.
hasActiveAudioSources equal to 1 indicates presence of information regarding the presence of active audio sources in a particular acoustic environment. Furthermore, the active audio sources could be due to interaction dependent presence of active audio source(s) in an AE, animation or static audio source(s) or due to a dynamic update(s) arriving during rendering run time. A value equal to 0 indicates that there are no active audio sources in a particular acoustic environment.
hasAESpecificConnectedReverbGainMultiplier equal to 1 indicates the presence of gain multiplier value which overrides the connectedReverbGainMultiplier value. The overriding value is specified by AEConnectedReverbGainMultiplier.
numberOfAcousticEnvironments defines the number of acoustic environments in the audio scene. The reverbPayloadStruct ( ) carries information regarding the one or more acoustic environments which are present in the audio scene at that time.
environment Id This value defines the unique identifier of the acoustic environment.
delayLineLength defines the length in units of samples for the graphic equalizer (GEQ) filter used for configuration of the attenuation filter. The lengths of different delay lines corresponding to the same acoustic environment are mutually prime.
filterParamsStruct ( ) this structure describes the graphic equalizer cascade filter to configure the attenuation filter for the delay lines. The same structure is also used subsequently to configure the filter for diffuse-to-direct reverberation ratio. The details of this structure are described in the next table.
   The Semantics of filterParamsStruct ( ) are as Follows
SOSLength is the length each of the second order section filter coefficients.
b1, b2, a1, a2 The filter is configured with coefficients b1, b2, a1 and a2.
globalGain specifies the gain factor in decibels for the GEQ.
levelDB specifies the sound level for each of the delay lines in decibels.

A further example of the Connected reverb bitstream information carrying information regarding the selected alternatives of connections to be considered by the renderer is also shown. Furthermore, the bitstream carries information regarding the priority of each of the alternatives. The priority indicates which of the connections are more important compared to the others. In an embodiment of the implementation, if the renderer is unable to render connected reverb with all the essential connections, an error indication “low resources” can be indicated to the user.

```
  reverbPayloadStruct( ){
  unsigned int(2) numberOfSpatialPositions;
  unsigned int(1) hasConnectedReverbDepthLimit;
  unsigned int(1) hasConnectedReverbGainMultiplier;
  unsigned int(1)
hasConnectedReverbActiveConnectionsInfoPresent;
  unsigned int(8) numberOfAcousticEnvironments;
  for(int i=0;i<numberOfSpatialPositions;i++){
    signed int(32) azimuth;
    signed int(32) elevation;
  }
  if(hasConnectedReverbDepthLimit){
    unsigned int(3) connectedReverbDepthLimit;
    reserved bits(5) = 0;
  }
  if(hasConnectedReverbGainMultiplier)
    unsigned int(8) connectedReverbGainMultiplier;
  reserved bits(3) = 0;
  for(int i=0;i<numberOfAcousticEnvironments;i++){
    unsigned int(16) environmentsId;
    filterParamsStruct( );
    unsigned int(1) hasActiveAudioSource;
    if(hasActiveAudioSource){
      unsigned int(1)
animated_audio_element_present;
      unsigned int(1) interactive element present;
      unsigned int(1)
dynamic_update_element_present;
      reserved bits(5) = 0;
    }
    unsigned int(1)
hasAESpecificConnectedReverbGainMultiplier;
    if(hasAESpecificConnectedReverbGainMultiplier){
      unsigned int(8)
AEConnectedReverbGainMultiplier;
    }
  if(hasConnectedReverbActiveConnectionsInfoPresent){
      ConnectedReverbActiveConnectionsInfoStruct( );
    }
    reserved bits(5) = 0;
    for(int j=0;j<numberOfSpatialPositions;j++){
      unsigned int(32) delayLineLength;
      filterParamsStruct( );
    }
  }
}
  aligned(8) filterParamsStruct( ){
  SOSLength;
  If(SOSLength>0){
    for (i=0;i<SOSLength;i++){
      signed int(32) b1;
    }
    for (i=0;i<SOSLength;i++){
      signed int(32) b2;
    }
    for (i=0;i<SOSLength;i++){
      signed int(32) a1;
    }
    for (i=0;i<SOSLength;i++){
      signed int(32) a2;
    }
  signed int(32) globalGain;
  signed int(32) levelDb;
  }
  }
  aligned(8)
ConnectedReverbActiveConnectionsInfoStruct( ){
  unsigned int(8)
numberOfActiveConnectionsAcousticEnvironments;
  for(int i=0;i<
numberOfActiveConnectionsAcousticEnvironments;i++){
    unsigned int(16) activeConnectionEnvironmentId;
    unsigned int(8) num_acoustic_coupling;
    for(int i=0;i<num_acoustic_coupling;i++){
      unsigned int(8) active_connection_priority;
      unsigned int(1)
hasActiveConnectionSpecificMultiplier;
      if(hasActiveConnectionSpecificMultiplier){
        unsigned int(8)
ConnectedReverbMultiplier;
      unsigned int(1) hasFeedbackAttenuationFilter;
      if(hasFeedbackAttenuationFilter){
        FeedbackAttenuationFilterStruct( );
    }
  }
}
  aligned(8) FeedbackAttenuationFilterStruct( ){
  filterParamsStruct( );
}
```

The difference between this and the earlier example being
hasConnectedReverbActiveConnections InfoPresent equal to 1 indicates the presence of information regarding the active connections between the acoustic environments in the bitstream for performing connected reverb rendering. A value equal to 0 indicates that the renderer can use the scene description to derive the active connections between the acoustic environments.
ConnectedReverbActiveConnections InfoStruct ( )
numberOfActiveConnectionsAcousticEnvironments defines the number of acoustic environments that are to be considered for connected reverb rendering.
hasConnectedReverbGainMultiplier equal to 1 indicates presence of information regarding the reverb output gain multiplier before feeding it as input to the next reverb for connected reverb rendering. A value equal to 0 indicates that this information is not present at a global level for all acoustic environments.
activeConnectionEnvironment Id indicates the acoustic environment with active connection with the current acoustic environment.
active connection priority indicates priority of the connection to be considered to while performing connected reverb rendering. A value of 255 is considered essential whereas a value of less than 255 is considered optional. This provides the renderer with flexibility in controlling the computational complexity of connected reverb rendering.
ConnectedReverbMultiplier defines the multiplier used for the output of the reverb before feeding it to the current AE reverb. This value is present if hasActiveConnectionSpecificMultiplier is equal to 1. The ConnectedReverbMultiplier overrides the value for the multiplier defined by AEConnectedReverbGainMultiplier as well as the connectedReverbGainMultiplier.
FeedbackAttenuationFilterStruct defines the coefficients for a feedback attenuation filter for a connection between acoustic environments if one exists.

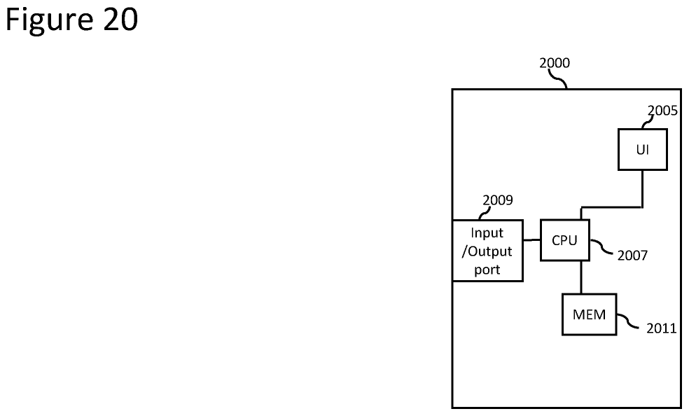

With respect to FIG. 20 an example electronic device which may be used as any of the apparatus parts of the system as described above. The device may be any suitable electronics device or apparatus. For example in some embodiments the device 2000 is a mobile device, user equipment, tablet computer, computer, audio playback apparatus, etc. The device may for example be configured to implement the encoder or the renderer or any functional block as described above.

In some embodiments the device 2000 comprises at least one processor or central processing unit 2007. The processor 2007 can be configured to execute various program codes such as the methods such as described herein.

In some embodiments the device 2000 comprises a memory 2011. In some embodiments the at least one processor 2007 is coupled to the memory 2011. The memory 2011 can be any suitable storage means. In some embodiments the memory 2011 comprises a program code section for storing program codes implementable upon the processor 2007. Furthermore in some embodiments the memory 2011 can further comprise a stored data section for storing data, for example data that has been processed or to be processed in accordance with the embodiments as described herein. The implemented program code stored within the program code section and the data stored within the stored data section can be retrieved by the processor 2007 whenever needed via the memory-processor coupling.

In some embodiments the device 2000 comprises a user interface 2005. The user interface 2005 can be coupled in some embodiments to the processor 2007. In some embodiments the processor 2007 can control the operation of the user interface 2005 and receive inputs from the user interface 2005. In some embodiments the user interface 2005 can enable a user to input commands to the device 2000, for example via a keypad. In some embodiments the user interface 2005 can enable the user to obtain information from the device 2000. For example the user interface 2005 may comprise a display configured to display information from the device 2000 to the user. The user interface 2005 can in some embodiments comprise a touch screen or touch interface capable of both enabling information to be entered to the device 2000 and further displaying information to the user of the device 2000. In some embodiments the user interface 2005 may be the user interface for communicating.

In some embodiments the device 2000 comprises an input/output port 2009. The input/output port 2009 in some embodiments comprises a transceiver. The transceiver in such embodiments can be coupled to the processor 2007 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The input/output port 2009 may be configured to receive the signals.

In some embodiments the device 2000 may be employed as at least part of the renderer. The input/output port 2009 may be coupled to headphones (which may be a headtracked or a non-tracked headphones) or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus for assisting spatial rendering in at least two acoustic environments, the apparatus comprising:
at least one processor; and
at least one memory storing instructions that, when executed with the at least one processor, cause the apparatus at least to:
obtain a listener position;
determine a first acoustic environment of the at least two acoustic environments based on the listener position;
determine at least one second acoustic environment of the at least two acoustic environments based on the first acoustic environment, wherein the second acoustic environment is coupled to the first acoustic environment with an active portal connection;
obtain at least one second acoustic environment input audio signal; and
generate at least one listener output audio signal based at least partly on the application of processing of the at least one second acoustic environment input audio signal with at least one second acoustic environment reverberator and a first acoustic environment reverberator.

2. The apparatus as claimed in claim 1, wherein the instructions, when executed with the at least one processor, cause the apparatus to:
obtain at least one third acoustic environment input audio signal; and
determine at least one further acoustic environment of the at least two acoustic environments, the at least one further acoustic environment coupled to the determined at least one second acoustic environment; and
wherein the instructions, when executed with the at least one processor, cause the apparatus to generate the at least one second acoustic environment input audio signal based at least partly on the application of processing of the at least one third acoustic environment input audio signal with at least one third acoustic environment reverberator.

3. The apparatus as claimed in claim 2, wherein the at least one third acoustic environment input is associated with at least one third acoustic environment reverberator parameter for configuring the at least one third acoustic environment reverberator.

4. The apparatus as claimed in claim 1, wherein the first acoustic environment is associated with at least one first acoustic environment reverberator parameter for configuring the first acoustic environment reverberator, and the second acoustic environment is associated with at least one second acoustic environment reverberator parameter for configuring the at least one second acoustic environment reverberator, wherein the instructions, when executed with the at least one processor, cause the apparatus to:
generate a second acoustic environment output audio signal based on the application of the second acoustic environment reverberator configured [by] with the at least one second acoustic environment reverberator parameter to the at least one second acoustic environment input audio signal; and
generate an output audio signal based on the application of the first acoustic environment reverberator configured with the at least one first acoustic environment reverberator parameter to the second acoustic environment output audio signal.

5. The apparatus as claimed in claim 1, wherein the active portal connection is one of:
a uni-directional connection from the second acoustic environment to the first acoustic environment; or
a bi-directional connection from the second acoustic environment to the first acoustic environment and from the first acoustic environment to the second acoustic environment.

6. The apparatus as claimed in claim 1, wherein the active portal connection is defined with respect to a distance within the first acoustic environment, such that the instructions, when executed with the at least one processor, cause the apparatus to determine the listener position is less than the distance within the first acoustic environment.

7. The apparatus as claimed in claim 6, wherein the instructions, when executed with the at least one processor, cause the apparatus to:
determine at least one audio element within the at least two acoustic environments; and
configure the distance within the first acoustic environment based at least partly on the determination of at least one audio element within the at least two acoustic environments, such that the distance is increased when there are no audio elements in the at least two acoustic environments.

8. The apparatus as claimed in claim 7, wherein the instructions, when executed with the at least one processor, cause the apparatus to:
obtain bitstream information defining at least one audio element; and
determine the at least one audio element based on the bitstream information.

9. The apparatus as claimed in claim 1, wherein the instructions, when executed with the at least one processor, cause the apparatus to obtain a list of the active portal connections for the acoustic environments, wherein the list identifies for a specified acoustic environment any acoustic environment acoustically coupled to the specified acoustic environment.

10. The apparatus as claimed in claim 9, wherein the instructions, when executed with the at least one processor, cause the apparatus to determine the second acoustic environment of the at least two acoustic environments based on the first acoustic environment, wherein the second acoustic environment is associated with at least one second acoustic environment reverberator parameter configured to employ the list of active portal connections to determine the second acoustic environment.

11. The apparatus as claimed in claim 9, wherein the list of the active portal connections for the acoustic environments comprises priority information associated with the list of the active portal connections for the acoustic environments, wherein the instructions, when executed with the at least one processor, cause the apparatus to determine the second acoustic environment of the at least two acoustic environments based on the first acoustic environment configured to determine the second acoustic environment based on the priority information.

12. The apparatus as claimed in claim 1, wherein the at least one second acoustic environment reverberator comprises at least one filter configured to attenuate at least one frequency.

13. The apparatus as claimed in claim 1, wherein the at least one first acoustic environment reverberator comprises at least one filter configured to attenuate at least one frequency.

14. The apparatus as claimed in claim 1, wherein the instructions, when executed with the at least one processor, cause the apparatus to apply one of:
a gain control multiplier; or
a feedback attenuation filter to an audio signal output with the second acoustic environment output audio signal before the application of the first acoustic environment reverberator.

15. An apparatus for assisting spatial rendering in at least two acoustic environments, the apparatus comprising:
at least one processor; and
at least one memory storing instructions that, when executed with the at least one processor, cause the apparatus at least to:
select a first acoustic environment of the at least two acoustic environments, wherein the first acoustic environment is associated with at least one first acoustic environment reverberator;
determine at least one second acoustic environment of the at least two acoustic environments wherein the at least one second acoustic environment is associated with at least one second acoustic environment reverberator and the second acoustic environment is coupled to the first acoustic environment with an active portal connection; and
generate a bitstream comprising information identifying the first acoustic environment and the at least one second acoustic environment coupled with the active portal connection.

16. The apparatus as claimed in claim 15, wherein the active portal connection is one of:
a uni-directional connection from the second acoustic environment to the first acoustic environment; or
a bi-directional connection from the second acoustic environment to the first acoustic environment and from the first acoustic environment to the second acoustic environment.

17. The apparatus as claimed in claim 15, wherein the information further comprises at least one reverberator parameter for configuring the acoustic environment reverberator.

18. The apparatus as claimed in claim 15, wherein the information further comprises priority information associated with the list of active portal connections for the acoustic environments.

19. A method for an apparatus for assisting spatial rendering in at least two acoustic environments, the method comprising:
obtaining a listener position;
determining a first acoustic environment of the at least two acoustic environments based on the listener position;
determining at least one second acoustic environment of the at least two acoustic environments based on the first acoustic environment, wherein the second acoustic environment is coupled to the first acoustic environment with an active portal connection;
obtaining at least one second acoustic environment input audio signal; and
generating at least one listener output audio signal based at least partly on the application of processing of the at least one second acoustic environment input audio signal with at least one second acoustic environment reverberator and a first acoustic environment reverberator.

20. A method for an apparatus for assisting spatial rendering in at least two acoustic environments, the method comprising:
selecting a first acoustic environment of the at least two acoustic environments, wherein the first acoustic environment is associated with at least one first acoustic environment reverberator;
determining at least one second acoustic environment of the at least two acoustic environments wherein the at least one second acoustic environment is associated with at least one second acoustic environment reverberator and the second acoustic environment is coupled to the first acoustic environment with an active portal connection; and
generating a bitstream comprising information identifying the first acoustic environment and the at least one second acoustic environment coupled with the active portal connection.

21-22. (canceled)
